(19) United States
(12) Patent Application Publication
(10) Pub. No.: US 2026/0051938 A1
(43) Pub. Date: Feb. 19, 2026

(54) SPATIAL ELEMENT ADAPTATION FOR NETWORK ENERGY SAVING

(71) Applicant: Intel Corporation, Santa Clara, CA (US)

(72) Inventors: Daewon Lee, Portland, OR (US); Toufiqul Islam, Santa Clara, CA (US); Seau Sian Lim, Swindon (GB); Hui Ma, Kanata (CA)

(21) Appl. No.: 19/147,941

(22) PCT Filed: Dec. 15, 2023
(86) PCT No.: PCT/US2023/084417

§ 371 Date: Jul. 14, 2025

Related U.S. Application Data
(60) Provisional application No. 63/484,970, filed on Feb. 14, 2023.

(51) Int. Cl. H04B 7/06; H04W 72/23

(52) U.S. Cl. CPC H04B 7/0626; H04W 72/23

(57) ABSTRACT

The present disclosure describes mechanisms to configure user equipment (UEs) with a set of channel state information (CSI) and/or measurement configurations, and mechanisms to indicate codepoints that activate or trigger selected ones of the configured CSI/measurement configures that individual UEs are to use to report CSI and/or other measurements. The set of configurations can indicate how individual UEs are to compute CSI and/or measurement feedback reports. The set of configurations can include information about which subset of antenna ports from a set of antenna port configurations, and potential transmission power offsets between CSI reference signal (CSI-RS) and physical downlink shared channel (PDSCH). The signaling mechanisms can include radio resource control (RRC) for the CSI/measurement configurations and/or downlink control information (DCI) signaling for activation/triggering of the selected CSI/measurement configurations. The activation/triggering signaling can include a limited number of bits to indicate the codepoints.

### CROSS REFERENCE TO RELATED APPLICATION

The present application claims priority to U.S. Provisional App. No. 63/484,970 filed on Feb. 14, 2023 (“'970”), the contents of which is hereby incorporated by reference in its entirety.

### BACKGROUND

In current cellular networks, a user equipment (UE) is usually configured with antenna elements and/or transmission power for certain reference signals via radio resource control (RRC) signaling, which can be relatively slow and/or incur relatively high latency. Additionally, this type of configuration usually takes place on a per-UE basis, which requires a large amount of RRC signalling to take place to configure multiple UEs and can result in overall high system overhead.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 depicts an example procedure for practicing various aspects of the present disclosure;

FIG. 2 depicts an example timing diagram related to various aspects of the present disclosure;

FIG. 3 depicts an example of spatial and power adaptation;

FIG. 4 depicts an example network architecture;

FIG. 5 depicts an example wireless network;

FIG. 6 depicts example hardware resources; and

FIGS. 7 and 8 depict example processes for practicing the various embodiments discussed herein.

### DETAILED DESCRIPTION

### 1. Spatial Element Adaptation Aspects

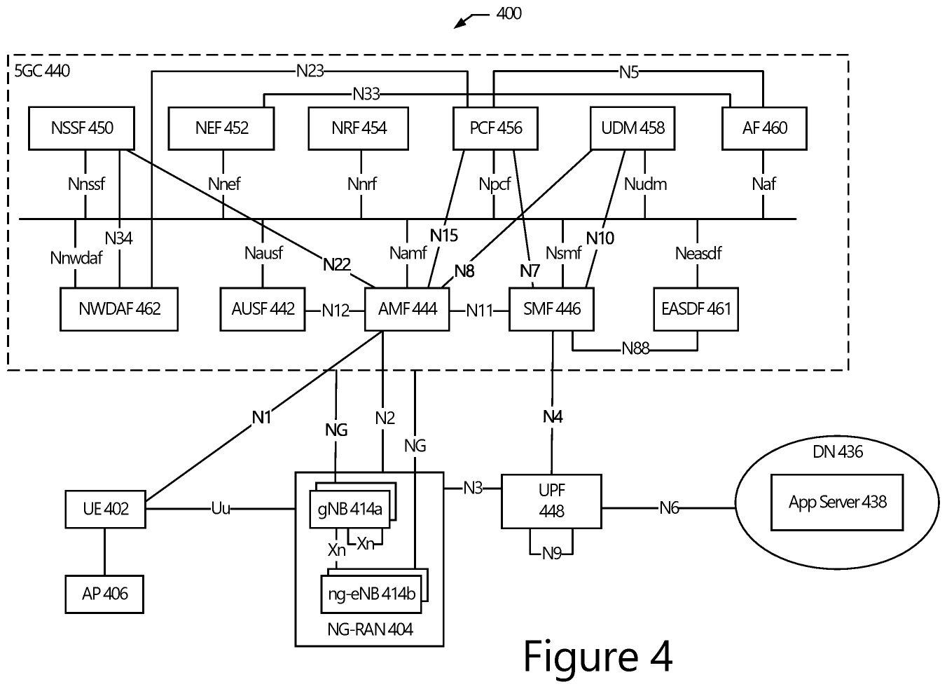

A RAN node (e.g., RAN node 414 of FIG. 4) can inform a user equipment (UE) (e.g., UE 402 of FIG. 4) of changes to antenna elements and/or transmission power for certain reference signals used by the RAN node 414. This is typically done using radio resource control (RRC) messaging (see e.g., 3GPP TS 38.331 (“[TS38331]”)) and can be slow (e.g., high latency). Also, the current configuration of number of antenna ports and transmission power of certain reference signals is configured on a per-UE basis. Therefore, mass configuration for all UEs 402 connected to the RAN node 414 requires the RAN node 414 to individually update the configuration using RRC, resulting in overall high system overhead.

Configuration of different antenna ports and transmission power levels for CSI-RS required for a RAN node 414 to update involves using RRC reconfiguration messaging. RRC reconfiguration messaging typically has a high latency to completion of the reconfiguration. In particular, RRC reconfiguration for individual UEs 402 also result in high system overhead in case multiple UEs 402 require RRC reconfiguration.

The present disclosure provides techniques and technologies to reduce configuration latency, reduce signaling overhead, and provide additional information that aids the RAN node 414 in determining the optimal number of antenna ports and transmission power needed to be used.

In various implementations, L1 signaling (e.g., downlink control signal and/or DCI) with limited number of bits that indicate codepoints is used to configure a group of UEs 402 (or a single UE 402) with which configuration to use. The RAN node 414 (pre-)configures the UEs 402 with a set of configurations that correspond to different codepoints of the L1 signaling. The set of configurations that is preconfigured may be also used for UE 402 to compute channel state information or measurement feedback. The set of configurations may include information of which subset of antenna ports from largest antenna port configuration, and potential transmission power offset between CSI-RS and PDSCH.

The aspects discussed herein allows RAN nodes 414 (e.g., gNBs, ng-eNBs, and/or the like) to perform switching of antenna elements and transmission power used for various signals and channels, with potentially lower signaling overhead. This allows the RAN node 414 to maximally leverage power saving benefits that stem from use of lower transmission power and smaller number of antenna elements. In case of higher system performances are needed, the fast adaptation of antenna elements and transmission power allow RAN node 414 to quickly come back to nominal state of operation and maximize overall system performance.

Aspects of the present disclosure may be relevant to various specifications and/or standards such as, for example, 3GPP TS 38.211 (“[TS38211]”), 3GPP TS 38.212 (“[TS38212]”), 3GPP TS 38.213 (“[TS38213]”), 3GPP TS 38.214 (“[TS38214]”), 3GPP TS 38.215 (“[TS38215]”), 3GPP TS 38.101-1 (“[TS38101-1]”), 3GPP TS 38.104 (“[TS38104]”), 3GPP TS 38.113 (“[TS38113]”), 3GPP TS 38.133 (“[TS38133]”), [TS38331], and/or other the like standards/specifications.

1.1. Configuration with Lower Latency and Lower Signaling Overhead

A RAN 414 depending on the power consumption profile that it is expecting to work with, may have different configurations for number of active antenna and transmission power settings. The RAN node may also have different configurations tailored to different UEs 402 based on UE capability and performance requirement to services the UEs 402.

Configuration for channel state information (CSI) reference signal (RS) may include number of antenna ports for the CSI-RS, power offset between CSI-RS resource element (RE) and secondary synchronization signal (SSS) RE, power offset between CSI-RS RE and physical downlink shared channel (PDSCH) RE, time/frequency RE within a slot used by the CSI-RS transmission, periodicity of the CSI-RS (in case periodicity of the transmission exist), and other various information required for generation, transmission and reception of the RS.

If the RAN node 414 needs to switch antenna and transmit power configurations for a group of UEs 402 to fulfill a different power consumption profile requirement, it needs to reconfigure all the UEs 402 in that group. Currently, antenna configurations, such as those related to CSI measurement and feedback, are configured using individual RRC messaging, where a separate and/or new configuration is required for each UE 402 separately. However, RRC signaling can potentially incur a relatively large latency penalty (e.g., in terms of resource usage and/or overhead). In addition, when a RAN node 414 needs to reconfigure a large number of UEs 402, the latency penalty of RRC signaling may be compounded or otherwise exacerbated by causing excessive system overhead and thereby causing additional latency in the network.

To combat the aforementioned issues, in some implementations, a RAN node 414 configures a set of UEs 402 with a set of configurations 111 corresponding to various power consumption profiles that the RAN node 414 may wish to optimize for. Among the set of configurations, using L1 signaling such as downlink control information (DCI) signaling or L2 signaling such as MAC CE or MAC PDU, indicates a selection among the configured parameters (e.g., indicated using RRC signaling) to a UE 402 (e.g., using UE specific C-RNTI) or a group of UEs 402 (e.g., using UE group specific or cell specific RNTI). The use of L1/L2 signaling provides a much faster information exchange with the UEs 402 in comparison to existing techniques, and allow signaling to be compressed to few bits that simply needs to indicate index among the set of configurations saving bandwidth.

Because the configurations may need to be received, decoded, and parsed by the UE 402, and then subsequent processing of the configuration for measurement and reporting, in some embodiments, an activation timer or application delay is considered or otherwise used. The activation timer or application delay is used to help determine the time period in which the configurations are considered to be valid by the RAN node 414 and UE 402. The application delay is used define a timer period after reception of the configuration, in which the configuration is applied. The activation timer is timer that counts down a time period, that is started to count down after reception of the configuration, before the configuration is applied.

In some examples, the activation timer or application delay may start right after or from K (K≥1) slots or symbols based on a given numerology, or P msec after the slot or end of symbol where the L1/L2 signaling was received. In another example, the activation timer or application delay can be fixed in specification or can be configured by higher layer signaling or can be provided by a L1 signaling which can be same or different than the L1 signaling which indicated the configuration(s) related to antenna and/or transmit power adjustments.

After the L1/L2 signaling, the UE 402 will use the indicated configuration for measurements and reporting among the pre-configured set of parameters. Later if the RAN node 414 sends an updated configuration selection by L1/L2 signaling, the UE 402 will repeat the process and use the newly selected configuration parameters for measurement and reporting.

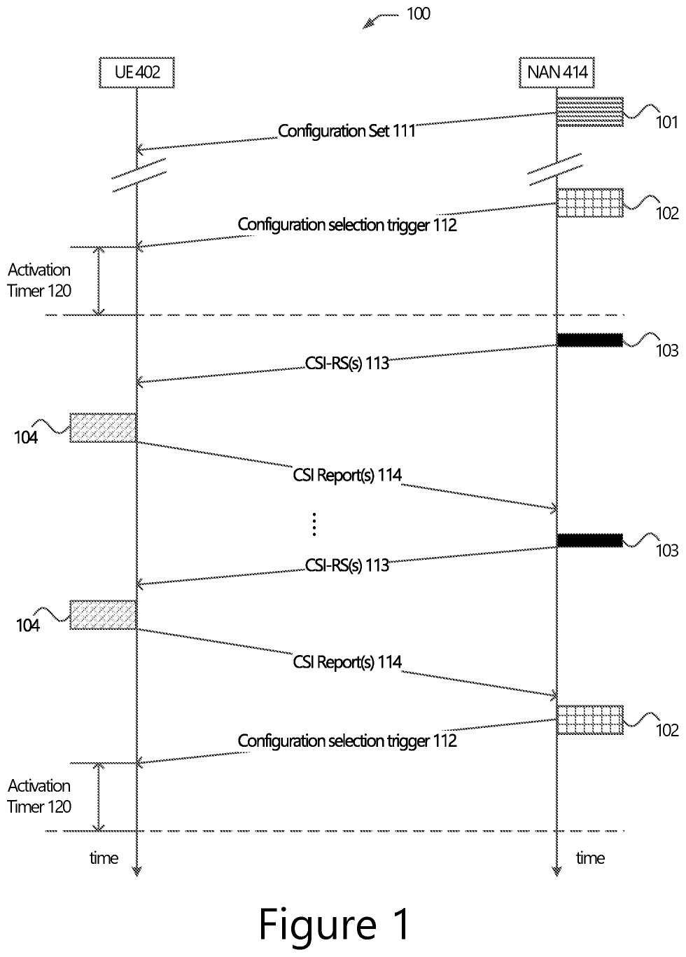

FIG. 1 depicts an example process 100 for receiving updated configuration parameters. Process 100 begins with operation 101 where radio resource control (RRC) signaling is sent from network access node (NAN) 414 (also referred to as “RAN node 414” or the like) to the UE 402, where the RRC signaling includes a set of one or multiple configurations (e.g., a configuration set 111). In some examples, the RRC message(s) 111 at operation 102 is/are sent over the physical downlink shared channel (PDSCH) if layer 2 (L2) signaling is used. In other examples, the RRC message(s) 111 at operation 102 is sent over the physical downlink control channel (PDCCH) if layer 1 (L1) signaling is used. Additional aspects related to RRC signaling and RRC messages 111 are discussed in [TS38331].

In various implementations, the configuration set 111 (or individual configurations or sub-configurations in the configuration set 111) indicates configurations of specific channel state information (CSI) components (e.g., CQI, PMI, CRI, SSBRI, LI, RI, L1-RSRP, L1-SINR, CapabilityIndex, TDCP, and/or other parameters discussed herein, in [TS38214], and/or other suitable standards/specifications) to be reported. The time and frequency resources that can be used by the UE 402 to report CSI are controlled by the RAN node 414 using individual configurations in the configuration set 111.

In some examples, a CSI-RS configuration in the configuration set 111 may be associated with N≥1 CSI-ReportConfig reporting settings, X≥1 LTM-CSI-ReportConfig reporting settings, M≥1 CSI-ResourceConfig resource settings, Y≥1 LTM-CSI-ResourceConfig resource settings, and/or one or two list(s) of trigger states (e.g., given by the higher layer parameters CSI-AperiodicTriggerStateList and CSI-SemiPersistentOnPUSCH-TriggerStateList). Additional aspects of CSI reporting setting, CSI resource settings, and/or other aspects of CSI configurations is/are discussed herein and/or as discussed in [TS38214]. Additionally or alternatively, a CSI-ReportConfig can contain a list of one or more sub-configurations, where each sub-configuration is identified by CSI report sub-configuration ID and corresponds to a list of one or more CSI-RS resources, corresponds to a CSI-RS antenna port subset, and/or corresponds to a power offset for PDSCH relative to CSI-RS. In some examples, a set of CSI-RS can be associated with an individual sub-configuration.

At operation 102, a configuration selection trigger 112 is signaled to the UE 402 (e.g., a new configuration selection trigger) that triggers CSI reporting. In some examples, the configuration selection trigger 112 is signaled in a suitable DCI format (e.g., DCI format 0_1, 0_2, 0_3, 2_9, and/or some other DCI format discussed herein and/or as discussed in [TS38212] and/or [TS38214]) and/or a medium access control (MAC) control element (CE) (see e.g., 3GPP TS 38.321 (“[TS38321]”) § 6.1.3.13). The UE 402, upon detection of a PDCCH with a configured DCI format, decodes the corresponding PDSCHs as indicated by that DCI. The UE 402 may receive and decode DCI according to the procedures discussed herein and/or in [TS38214]. Additional aspects of triggering/activation of CSI reports and CSI-RS are discussed herein and/or in [TS38214].

The UE 402 may apply the configuration(s) indicated by the configuration selection trigger 112 during an activation timer 120 and/or after expiration of the activation timer 120. As mentioned previously, the activation timer 120 is used to allow the UE 402 to receive, decode, and/or parse the relevant configuration(s), and subsequent processing of the relevant configuration(s) for measurement and reporting. Additionally or alternatively, the activation timer 120 is used to help determine the time period in which the configurations are considered to be valid by the RAN node 414 and UE 402. The application delay (or activation timer value) is used define an activation time period after reception of the configuration selection trigger 112 in which to apply the selected/indicated configuration(s). Additionally or alternatively, the activation timer 120 is a timer that counts down the activation time period, which is started to count down after reception of the configuration selection trigger 112 before the configuration is applied. In some examples, the activation timer 120 may start right after or from K slots or symbols (e.g., where K≥1) based on a given numerology. Additionally or alternatively, the activation timer 120 may start P milliseconds (ms) after the slot or end of the symbol where the L1/L2 signaling (e.g., the configuration selection trigger 112) was received.

In some examples, the activation timer value (or application delay value) can be a fixed value defined in suitable standards/specifications. Additionally or alternatively, the activation timer value (or application delay value) can be configured by higher layer signaling (e.g., included in the configuration set(s) 111, in a separate information element (IE) in the RRC message carrying the configuration set(s) 111, configured via a separate or different RRC message, and/or the like). Additionally or alternatively, the activation timer value (or application delay value) can be configured or otherwise indicated by a L1 signaling, which can be same or different than the L1 signaling which indicated the configuration(s) related to antenna and/or transmit power adjustments (e.g., the configuration selection trigger 112). Additionally or alternatively, the activation timer and/or application delay can be calculated or started according to section 1.6.4, infra.

At operation 103, CSI-RS(s) 113 based on the configuration(s) provided at operation 102 are signaled to the UE 402. At operation 104, CSI feedback report(s) 114 (also referred to as “CSI-RS report(s)”) is generated by the UE 402 based on the CSI-RS(s) signaled at operation 103, and the CSI-RS report(s) 114 is/are signaled to the RAN node 414.

As alluded to previously, the CSI includes one or more of Channel Quality Indicator (CQI), precoding matrix indicator (PMI), CSI-RS resource indicator (CRI), SS/PBCH Block Resource indicator (SSBRI), layer indicator (LI), rank indicator (RI), L1-RSRP, L1-SINR, CapabilityIndex, time-domain channel properties (TDCP), and/or additional or alternative parameters, such as those discussed in [TS38214].

In some examples, individual CSI feedback reports 114 refer to individual CSI reports and/or individual CSI sub-reports included in a CSI report. Additional aspects of CSI reports and CSI sub-reports are discussed infra. Additionally or alternatively, the CSI and/or the CSI reports 114 may be included in uplink control information (UCI) on PUCCH and/or PUSCH as discussed in [TS38212] and/or [TS38214]. Additional aspects of UCI is/are discussed infra.

Additionally or alternatively, assistance information from the UE 402 can be provided to the RAN node 414 so that the RAN node 414 can make the appropriate determination of power consumption profiles. In some implementations, the UE 402 can provide multiple CSI feedback and/or multiple CSI reports 114 to the RAN node 414, where each CSI feedback and/or CSI report 114 corresponds to a potential configuration of antenna and/or transmit power. For example, multiple CSIs can be included in a single CSI report 114 (e.g., CSI reports and/or CSI sub-reports). In these examples, individual CSI feedback reports 114 can be conveyed to the RAN node 414 in a single message or in multiple separate messages.

Based on the CSI feedback report(s) 114, the RAN node 414 can make decisions to pick and choose a specific antenna and/or transmit power configuration that could potentially enhance the system throughput/latency performance, and at the same time reduce the power consumption of the RAN node 414. Additional aspects related to CSI-RS signaling and CSI feedback 113 are discussed in [TS38211], [TS38212], [TS38213], [TS38214], and/or other suitable standards/specifications.

A UE 402 being able to provide CSI feedback 114 for a hypothetical configuration (of CSI-RS(s) 113) may only be possible if the UE 402 is able to perform measurements. This implies, when the RAN node 414 is transmitting CSI-RSs 113 corresponding to the full set of antenna elements, UE 402 can perform measurements with full set of antenna elements as well as measurement for a subset of the antenna elements. If the RAN node 414 configures to only use a subset of certain antenna elements (or ports), then it will not be possible for the UE 402 to perform measurements for full set of antennas.

To combat this issue, in some implementations, RAN node 414 may configure two sets of CSI reporting. The first CSI reporting is based on measurements of configuration of potentially larger number of CSI-RS antenna ports. The first CSI reporting may provide multiple CSI feedback reports 114 that correspond to several hypothetical CSI-RS configurations, which are subset of the configured CSI-RS ports, and/or several hypothetical configurations of power offsets between PDSCH and CSI-RS 113. Reporting of multiple CSI feedback 114 based on different set of CSI-RS antenna ports and/or transmission power offsets between PDSCH and CSI-RS 113 allows the RAN node 414 to determine a suitable selection for optimal network operations. The second CSI reporting may correspond to regular CSI-RS reporting that contains the CSI feedback 114 based on configured CSI-RS 113, which may have different configuration compared to CSI-RS configuration for the first CSI report(s) 114.

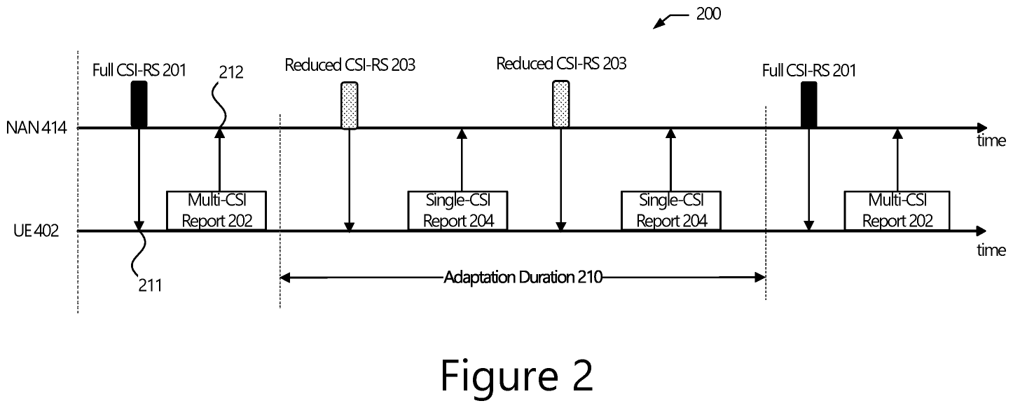

FIG. 2 shows an example 200 of first CSI and second CSI reports 114, which may be sent by a UE 402 to a RAN node 414. Here, the RAN node 414 transmits CSI-RS 201 (e.g., full CSI-RS 201) with N antenna ports (where N is a number) that allows the UE 402 to perform multiple CSI feedback 202 for multiple hypothetical CSI-RS configurations 211 (e.g., for N antenna ports, N/2 antenna ports, N/4 antenna ports, and/or the like). Here, the multiple hypothetical CSI-RS configurations 211 configure multiple CSI reports, each of which correspond to different number of antenna ports. Based on feedback 202, determines an optimal antenna/power configuration.

After the first CSI report 202 (e.g., multi-CSI report 202), the RAN node 414 configures and transmits a different set of CSI-RS(s) 203 (e.g., reduced CSI-RS 203) that has M antenna ports (e.g., where M is a number, and M≤N) in which the UE 402 performs measurements and reports a CSI feedback 204, for example, based on antenna configurations and/or ports associated with the CSI-RS(s) 203. In example 200, the CSI-RSs 201, 203 may correspond to the CSI-RSs 113 of FIG. 1, and the CSI reports 202, 204 may correspond to the CSI reports 114 of FIG. 1.

An adaptation duration 210 represent the period between the CSI-RS 201 and the corresponding multi-CSI feedback report 202 in which the RAN node 414 can perform adaptation of the antenna elements and transmission power for various signals and channels.

In some embodiments, an indication as to whether to combine multiple CSI-RS reports 114 into a single report can be signaled to the UE 402, for example, using higher layer signaling (e.g., RRC signaling) and/or via downlink control information (DCI) indication (e.g., using any of the DCI formats discussed in [TS38212] or a new DCI format).

Additionally or alternatively, after the RAN node 414 indicates a certain framework for CSI reporting (e.g., multiple CSI report 202 or single CSI report 204), it can be assumed by the UE 402 to be effective for a certain validity duration. In some examples, the UE 402 may switch between multiple CSI report 202 and single CSI report 204 upon expiry of a timer/validity duration, until a DCI indicates to switch, and/or when the RAN node 414 provides a CSI-RS configuration (e.g., configuration set(s) 101 in FIG. 1) for which a certain type of reporting maybe needed.

### 1.2. Multiple CSI-RS Configuration for Spatial and Power Adaptation

When the RAN node 414 configures a set of CSI-RS configurations that contain multiple CSI-RS configurations where one or more of the CSI-RS configurations corresponds to a specific reduction of a number of antenna and/or specific transmission power configuration (e.g., power offset between CSI-RS and PDSCH), instead of explicitly configuring multiple CSI-RS configurations, in some implementations, the RAN node 414 indicates a CSI-RS configuration, denoted as a first CSI-RS configuration, with a set of antenna port subset indication and/or transmission power offset values (potentially corresponding to a new power control offset that indicates Power offset of PDSCH resource element (RE) to CSI-RS RE, and power offset of CSI-RS RE to secondary synchronization signal RE).

In some examples, the antenna port subset indication (e.g., provided in a DCI) may be a bitmap that indicates which antenna ports of the first CSI-RS configuration is used or not used. Additionally or alternatively, the antenna port subset indication can be a index that corresponds to pre-defined patterns of enabled (or disabled) CSI-RS antenna ports.

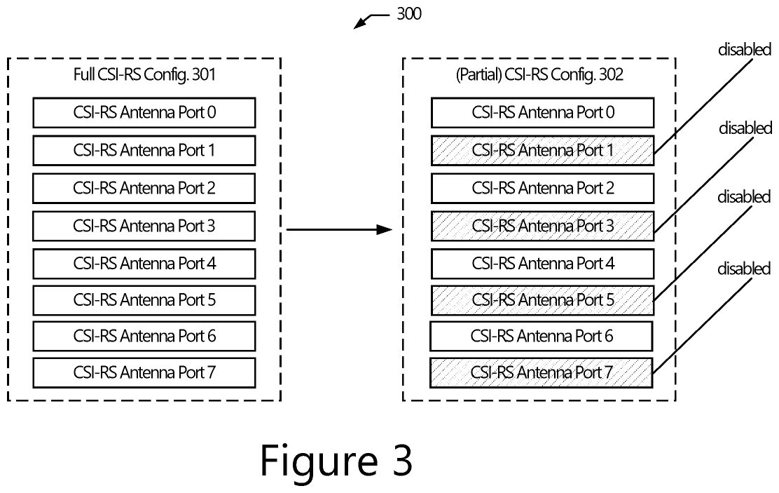

FIG. 3 shows an example 300 where a first CSI-RS configuration (referred to as a full CSI-RS 301), and a second CSI-RS configuration (referred to as a partial CSI-RS 302) indicated by an antenna port subset is provided to the UE 402. In example 300, the antenna port subset field indicates that CSI-RS antenna ports 1, 3, 5, and 7 are disabled.

Additionally or alternatively to using a bitmap indication of CSI-RS antenna port enablement and disablement, the antenna port subset field can indicate a predefined or configurable patterns of CSI-RS antenna port enablement and/or disablement. In these examples, the configuration trigger (e.g., DCI and/or MAC CE) can include a suitable index that points to or otherwise indicates the appropriate CSI-RS antenna port enablement and/or disablement pattern to use. For example, if the number of antenna port configured for the first CSI-RS configuration is N, some example antenna port enablement and disablement patterns are shown by table 1.2-1.

TABLE 1.2-1
example antenna port enablement and disablement patterns

| Pattern | |
|---|---|
| Index | Antenna port enable/disable pattern |
| 1 | N/2 antenna ports, every odd port index disabled |
| 2 | N/2 antenna ports, every even port index disabled |
| 3 | N/2 antenna ports, antenna port index 0 to ‘N/2 − 1’ disabled |
| 4 | N/2 antenna ports, antenna port index ‘N/2’ to ‘N − 1’ disabled |
| 5 | N/4 antenna ports, only antenna port index 4*k enabled, where k = 0, 1, . . . , N/4 − 1 |
| 6 | N/4 antenna ports, only antenna port index 4*k + 1 enabled, where k = 0, 1, . . . , N/4 − 1 |
| 7 | N/4 antenna ports, only antenna port index 4*k + 2 enabled, where k = 0, 1, . . . , N/4 − 1 |
| 8 | N/4 antenna ports, only antenna port index 4*k + 3 enabled, where k = 0, 1, . . . , N/4 − 1 |
| 9 | Antenna port with index k, k = 0, 1, . . . , N/4 − 1, enabled |
| 10 | Antenna port with index k, k = N/4, N/4 + 1, . . . , N/2 − 1, enabled |
| 11 | Antenna port with index k, k = N/2, N/2 + 1, . . . , 3/4*N − 1, enabled |
| 12 | Antenna port with index k, k = 3/4*N, 3/4*N + 1, . . . , N − 1, enabled |

In the example of table 1.2-1, N is the number of CSI-RS antenna ports configured by the CSI configuration and/or an individual sub-configurations. In some examples, the aforementioned examples of CSI RS antenna port and/or transmit power adaptation is only applicable in the active DL BWP where the indication is received in a given carrier or in a cell.

### 1.3. Uplink Control Information Aspects

### 1.3.1. Uplink Control Information on Pucch

The procedure in this section may apply to PUCCH formats 2/3/4. Clauses 6.3.1.2, 6.3.1.3 and 6.3.1.5 in [TS38212] apply regardless of whether the higher layer parameter uci-MuxWithDiffPrio is configured or not, and clauses 6.3.1.1, 6.3.1.4 and 6.3.1.6 in [TS38212] apply by assuming uci-MuxWithDiffPrio is not configured, or uci-MuxWithDiffPrio is configured and the UCIs for transmission on a PUCCH are of the same priority index, unless stated otherwise. If the UE 402 is configured with a PUCCH-SCell, uci-MuxWithDiffPrio is replaced by uci-MuxWithDiffPrioSecondaryPUCCHgroup for the secondary PUCCH group in this section and the following sub-sections.

### 1.3.1.1. Uci Bit Sequence Generation: CSI Only

If cqi-BitsPerSubband is configured, this clause and/or [TS38212] § 6.3.1.1.2 applies by taking Subband CQI as Subband differential CQI and replacing the corresponding number of bits 2 by 4. If csi-ReportSubConfig is configured, for a corresponding CSI sub-report, the bitwidth of a CSI field of the CSI sub-report is determined following the procedure in this clause and/or in [TS38212] § 6.3.1.1.2 by taking configurations in CSI-ReportSubConfig when applicable. If csi-ReportSubConfig configures a list of CSI-RS resource IDs, for the determination of the bitwidth of a CRI field, the value of

$${K}_{s}^{CSI - RS}$$

is the number of CSI-KS resources configured in the corresponding csi-ReportSubConfig.

The bitwidths for various combinations of PMI, CSI-RS ports, RI, LI, CQI, CRI, codebook types (codebookType), report quantities (reportQuantity), CSI-RS resource pairs, CSI report modes (csi-ReportModes), SSBRI, RSRP, differential RSRP, CapabilityIndex, SSBRI, SINR, differential SINR, as well as the mapping order of various combinations of CSI fields are provided in [TS38212] § 6.3.1.1.2. Additionally or alternatively, a new Table 6.3.1.1.2-11C (as shown infra) can be added to [TS38212] to reflect the CSI mapping order for a CSI report containing

$${N}_{n}^{s u b}$$

CSI sub-report(s), CSI part 2 subband, pmi-FormatIndicator=subbandPMI or cqi-FormatIndicator=subbandCQI.

If csi-ReportSubConfig is configured, for a corresponding CSI sub-report, the mapping order of CSI fields of one CSI sub-report is determined following the procedure in this clause 1.3.1.1 and/or in [TS38212] § 6.3.1.1.2, by replacing CSI report #n in the Tables 6.3.1.1.2-7, 6.3.1.1.2-9 and 6.3.1.1.2-10 with CSI sub-report #n, and taking only Tables 6.3.1.1.2-1/2/3/4 in [TS38212] for the determination of the bitwidth of a CSI field.

TABLE 6.3.1.1.2-11C
$Mapping order of CSI files of one CSI report containing {N}_{n}^{sub} CSI sub - report ( s ) ,$
CSI part 2 subband, pmi-FormatIndicator= subbandPMI or cqi-
FormatIndicator =subbandCQI

| | |
|---|---|
| CSI report | Subband differential CQI of CSI sub-report #1 for the second TB of all even subbands with |
| #n | increasing order of subband number, as in Tables 6.3.1.1.2-3/4 of [TS38212], if cqi- |
| Part 2 | FormatIndicator=subbandCQI and if reported |
| subband | PMI subband information fields X₂ of CSI sub-report #1 of all even subbands with increasing order |
| | of subband number, from left to right as in Tables 6.3.1.1.2-1/2 of [TS38212], or codebook index for |
| | 2 antenna ports of CSI sub-report #1 according to Clause 5.2.2.2.1 in [TS38214] of all even |
| | subbands with increasing order of subband number, if pmi-FormatIndicator= subbandPMI and if |
| | reported |
| | Subband differential CQI of CSI sub-report #2 for the second TB of all even subbands with |
| | increasing order of subband number, as in Tables 6.3.1.1.2-3/4 of [TS38212], if cqi- |
| | FormatIndicator=subbandCQI and if reported |
| | PMI subband information fields X2 of CSI sub-report #2 of all even subbands with increasing order |
| | of subband number, from left to right as in Tables 6.3.1.1.2-1/2, or codebook index for 2 antenna |
| | ports of CSI sub-report #2 according to Clause 5.2.2.2.1 in [TS38214] of all even subbands with |
| | increasing order of subband number, if pmi-FormatIndicator= subbandPMI and if reported |
| | . . . |
| | $Subband differential CQI of CSI sub - report {\# N}_{n}^{s u b} for the second TB of all even subbands with$ |
| | increasing order of subband number, as in Tables 6.3.1.1.2-3/4 of [TS38212], if cqi- |
| | FormatIndicator=subbandCQI and if reported |
| | $PMI subband information fields {X}_{2} of CSI sub - report {\# N}_{n}^{sub} of all even subbands with increasing$ |
| | order of subband number, from left to right as in Tables 6.3.1.1.2-1/2 of [TS38212], or codebook |
| | $index for 2 antenna ports of CSI sub - report {\# N}_{n}^{sub} according to Clause 5.2 \text{.2} \text{.1} in [ TS 38214 ] of$ |
| | all even subbands with increasing order of subband number, if pmi-FormatIndicator= subbandPMI |
| | and if reported |
| | Subband differential CQI of CSI sub-report #1 for the second TB of all odd subbands with |
| | increasing order of subband number, as in Tables 6.3.1.1.2-3/4 of [TS38212], if cqi- |
| | FormatIndicator=subbandCQI and if reported |
| | PMI subband information fields X2 of CSI sub-report #1 of all odd subbands with increasing order of |
| | subband number, from left to right as in Tables 6.3.1.1.2-1/2 of [TS38212], or codebook index for 2 |
| | antenna ports of CSI sub-report #1 according to Clause 5.2.2.2.1 in [TS38214] of all odd subbands |
| | with increasing order of subband number, if pmi-FormatIndicator= subbandPMI and if reported |
| | Subband differential CQI of CSI sub-report #2 for the second TB of all odd subbands with |
| | increasing order of subband number, as in Tables 6.3.1.1.2-3/4 of [TS38212], if cqi- |
| | FormatIndicator=subbandCQI and if reported |
| | PMI subband information fields X2 of CSI sub-report #2 of all odd subbands with increasing order of |
| | subband number, from left to right as in Tables 6.3.1.1.2-1/2 of [TS38212], or codebook index of for |
| | 2 antenna ports CSI sub-report #2 according to Clause 5.2.2.2.1 in [TS38214] of all odd subbands |
| | with increasing order of subband number, if pmi-FormatIndicator= subbandPMI and if reported |
| | . . . |
| | $Subband differential CQI of CSI sub - report {\# N}_{n}^{sub} for the second TB of all odd subbands with$ |
| | increasing order of subband number, as in Tables 6.3.1.1.2-3/4 of [TS38212], if cqi- |
| | Formatindicator=subbandCQI and if reported |
| | $PMI subband information fields {X}_{2} of CSI sub - report {\# N}_{n}^{sub} of all odd subbands with increasing$ |
| | order of subband number, from left to right as in Tables 6.3.1.1.2-1/2 of [TS38212], or codebook |
| | $index for 2 antenna ports of CSI sub - report {\# N}_{n}^{sub} according to Clause 5.2 \text{.2} \text{.1} in [ TS 38214 ] of$ |
| | all odd subbands with increasing order of subband number, if pmi-FormatIndicator= subbandPMI |
| | and if reported |

Note:
Subbands for given CSI report n indicated by the higher layer parameter csi-ReportingBand with value set to ′1′ are numbered continuously in the increasing order with the lowest subband of csi-ReportingBand with value set to ′1′ as subband 0.
$CSI sub - report \#1 , CSI sub - report \#2 , … , CSI sub - report {\# N}_{n}^{sub} correspond to the CSI sub - reports$ in increasing order of CSI-ReportSubConfigID.

Additionally or alternatively, the mapping order of UCI bit sequence(s) for different CSI reports are provided by Tables 6.3.1.1.2-12, 6.3.1.1.2-13, and 6.3.1.1.2-14 in [TS38212]. In some examples, for a CSI report #i containing

$${N}_{i}^{s u b}$$

CSI sub-reports, where i∈{1, 2, . . . , n}, either all CSI sub-reports not of two parts or CSI part 1 of all CSI sub-reports of two parts, are mapped to the corresponding segment of the UCI bit sequence of CSI report #i, from upper part to lower part of the segment, in increasing order of CSI sub-report number. CSI sub-report #1, CSI sub-report #2, . . . , CSI sub-report #

$${N}_{i}^{s u b}$$

correspond to the CSI sub-reports in increasing order of CSI-ReportSubConfigID.

### 1.3.2. Uplink Control Information on Pusch

Code block segmentation and CRC attachment, channel coding of UCI, and code block concatenation (see e.g., [TS38212] §§ 6.3.2.2, 6.3.2.3, and 6.3.2.5) apply regardless of whether the higher layer parameter uci-MuxWithDiffPrio is configured or not, and UCI bit sequence generation, rate matching, and multiplexing of coded UCI bits to PUSCH (see e.g., [TS38212] §§ 6.3.2.1, 6.3.2.4, and 6.3.2.6 in [TS38212]) apply by assuming uci-MuxWithDiffPrio is not configured, or uci-MuxWithDiffPrio is configured and the UCIs for transmission on a PUSCH are of the same priority index, unless stated otherwise.

If the UE 402 is configured with a PUCCH-SCell, uci-MuxWithDiffPrio is replaced by uci-MuxWithDiffPrioSecondaryPUCCHgroup for the secondary PUCCH group in this clause and the following sub-clauses.

### 1.3.2.1. UCI Bit Sequence Generation: CSI

If cqi-BitsPerSubband is configured, this clause and/or [TS38212] § 6.3.2.1.2 applies by taking Subband CQI as Subband differential CQI and replacing the corresponding number of bits 2 by 4.

If csi-ReportSubConfig is configured, for a corresponding CSI sub-report, the bitwidth of a CSI field of the CSI sub-report is determined following the procedure in this clause and/or [TS38212] § 6.3.2.1.2 by taking configurations in CSI-ReportSubConfig when applicable. If csi-ReportSubConfig configures a list of CSI-RS resource IDs, for the determination of the bitwidth of a CRI field, the value of

$${K}_{s}^{CSI - RS}$$

is the number of CSI-KS resources configured in the corresponding csi-ReportSubConfig.

The bitwidths for various combinations of PMI, CSI-RS ports, RI, LI, CQI, CRI, codebook types (codebookType), report quantities (reportQuantity), CSI-RS resource pairs, CSI report modes (csi-ReportModes), SSBRI, RSRP, differential RSRP, CapabilityIndex, SSBRI, SINR, differential SINR, as well as the mapping order of various combinations of CSI fields are provided in [TS38212] § 6.3.2.1.2. Additionally or alternatively, a new Table 6.3.2.1.2-5H (as shown infra) can be added to [TS38212] to reflect the CSI mapping order for CSI fields of one CSI report containing

$${N}_{n}^{s u b}$$

CSI sub-report(s), CSI part 2 subband.

If csi-ReportSubConfig is configured, for a corresponding CSI sub-report, the mapping order of CSI fields of one CSI sub-report is determined following the procedure in this clause and/or [TS38212] § 6.3.2.1.2 by replacing CSI report #n in Tables 6.3.2.1.2-3 and 6.3.2.1.2-4 in [TS38212] with CSI sub-report #n, and taking only Tables 6.3.1.1.2-1/2/3/4 in [TS38212] for the determination of the bitwidth of a CSI field.

TABLE 6.3.2.1.2-5H
$Mapping order of CSI files of one CSI report containing {N}_{n}^{sub} CSI sub - report ( s ) ,$
CSI part 2 subband

| | |
|---|---|
| CSI report | Subband differential CQI of CSI sub-report #1 for the second TB of all even subbands with |
| #n | increasing order of subband number, as in Tables 6.3.1.1.2-3/4 in [TS38212], if cqi- |
| Part 2 | FormatIndicator=subbandCQI and if reported |
| subband | PMI subband information fields X₂ of CSI sub-report #1 of all even subbands with increasing |
| | order of subband number, from left to right as in Tables 6.3.1.1.2-1/2 in [TS38212], or codebook |
| | index for 2 antenna ports of CSI sub-report #1 according to Clause 5.2.2.2.1 in [TS38214]of all |
| | even subbands with increasing order of subband number, if pmi-FormatIndicator=subbandPMI |
| | and if reported |
| | Subband differential CQI of CSI sub-report #2 for the second TB of all even subbands with |
| | increasing order of subband number, as in Tables 6.3.1.1.2-3/4 in [TS38212], if cqi- |
| | FormatIndicator=subbandCQI and if reported |
| | PMI subband information fields X₂ of CSI sub-report #2 of all even subbands with increasing |
| | order of subband number, from left to right as in Tables 6.3.1.1.2-1/2 in [TS38212], or codebook |
| | index for 2 antenna ports of CSI sub-report #2 according to Clause 5.2.2.2.1 in [TS38214]of all |
| | even subbands with increasing order of subband number, if pmi-FormatIndicator=subbandPMI |
| | and if reported |
| | . . . |
| | $Subband differential CQI of CSI sub - report {\# N}_{n}^{sub} for the second TB of all even subbands with$ |
| | increasing order of subband number, as in Tables 6.3.1.1.2-3/4 in [TS38212], if cqi- |
| | FormatIndicator=subbandCQI and if reported |
| | $PMI subband information fields {X}_{2} of CSI sub - report {\# N}_{n}^{sub} of all even subbands with increasing$ |
| | order of subband number, from left to right as in Tables 6.3.1.1.2-1/2 in [TS38212], or codebook |
| | $index for 2 antenna ports of CSI sub - report {\# N}_{n}^{sub} according to Clause 5.2 \text{.2} \text{.1} in [ TS 38214 ] of$ |
| | all even subbands with increasing order of subband number, if pmi-FormatIndicator= |
| | subbandPMI and if reported |
| | Subband differential CQI of CSI sub-report #1 for the second TB of all odd subbands with |
| | increasing order of subband number, as in Tables 6.3.1.1.2-3/4 in [TS38212], if cqi- |
| | FormatIndicator=subbandCQI and if reported |
| | PMI subband information fields X₂ of CSI sub-report #1 of all odd subbands with increasing |
| | order of subband number, from left to right as in Tables 6.3.1.1.2-1/2 in [TS38212], or codebook |
| | index for 2 antenna ports of CSI sub-report #1 according to Clause 5.2.2.2.1 in [TS38214]of all |
| | odd subbands with increasing order of subband number, if pmi-FormatIndicator=subbandPMI |
| | and if reported |
| | Subband differential CQI of CSI sub-report #2 for the second TB of all odd subbands with |
| | increasing order of subband number, as in Tables 6.3.1.1.2-3/4 in [TS38212], if cqi- |
| | FormatIndicator=subbandCQI and if reported |
| | PMI subband information fields X2 of CSI sub-report #2 of all odd subbands with increasing |
| | order of subband number, from left to right as in Tables 6.3.1.1.2-1/2 in [TS38212], or codebook |
| | index for 2 antenna ports of CSI sub-report #2 according to Clause 5.2.2.2.1 in [TS38214]of all |
| | odd subbands with increasing order of subband number, if pmi-FormatIndicator=subbandPMI |
| | and if reported |
| | . . . |
| | $Subband differential CQI of CSI sub - report {\# N}_{n}^{sub} for the second TB of all odd subbands with$ |
| | increasing order of subband number, as in Tables 6.3.1.1.2-3/4 in [TS38212], if cqi- |
| | Formatindicator=subbandCQI and if reported |
| | $PMI subband information fields {X}_{2} of CSI sub - report {\# N}_{n}^{sub} of all odd subbands with increasing$ |
| | order of subband number, from left to right as in Tables 6.3.1.1.2-1/2 in [TS38212], or codebook |
| | $index for 2 antenna ports of CSI sub - report {\# N}_{n}^{sub} according to Clause 5.2 \text{.2} \text{.1} in [ TS 38214 ] of$ |
| | all odd subbands with increasing order of subband number, if pmi-FormatIndicator= |
| | subbandPMI and if reported |

Note:
Subbands for given CSI report n indicated by the higher layer parameter csi-ReportingBand with value set to ′1′are numbered continuously in the increasing order with the lowest subband of csi-ReportingBand with value set to ′1′as subband 0.
$CSI sub - report \#1 , CSI sub - report \#2 , … , CSI sub - report {\# N}_{n}^{sub} correspond to the CSI sub - reports$ in increasing order of CSI-ReportSubConfigID.

### 1.4. DCI Format 2_9

The DCI formats defined in table 7.3.1-1 in [TS38214] are supported and can be used for any of the example implementations discussed herein. In some examples, DCI format 2_9 can be used for activating or de-activating the cell DTX and/or DRX configuration of one or multiple serving cells for one or more UEs 402. In these examples, the following information is transmitted by means of the DCI format 2_9 with CRC scrambled by NES-RNTI and/or cellDTRX-RNTI: block number 1, block number 2, . . . , block number N where the starting position of a block is determined by the parameter positionInDCI-cellDTRX provided by higher layers for the UE 402.

### 1.5. UCI Reporting in PUCCH

UCI types reported in a PUCCH include HARQ-ACK information, SR, LRR, and CSI. UCI bits include HARQ-ACK information bits, if any, SR information bits, if any, LRR information bit, if any, and CSI bits, if any. The HARQ-ACK information bits correspond to a HARQ-ACK codebook as described in [TS38213] § 9.1. For purposes of the present disclosure, any reference to SR is applicable for SR and/or for LRR. Aspects of UCI reporting in PUCCH not described herein are described in [TS38213] § 9.2.

### 1.5.1. UE Procedure for Reporting Multiple Uci Types

A UE 402 multiplexes DL HARQ-ACK information, with or without SR, and CSI report(s) in a same PUCCH if the UE 402 is provided simultaneousHARQ-ACK-CSI; otherwise, the UE 402 drops the CSI report(s) and includes only DL HARQ-ACK information, with or without SR, in the PUCCH. If the UE 402 would transmit multiple PUCCHs in a slot that include DL HARQ-ACK information and CSI report(s), the UE 402 expects to be provided a same configuration for simultaneousHARQ-ACK-CSI each of PUCCH formats 2, 3, and 4.

If a UE 402 would multiplex CSI reports that include Part 2 CSI reports in a PUCCH resource, the UE 402 determines the PUCCH resource and a number of PRBs for the PUCCH resource or a number of Part 2 CSI reports assuming that each of the CSI reports and, if any, each CSI sub-report included in a CSI report, indicates rank 1, or rank combination of {1, 1} if applicable. If the higher layer parameter csi-ReportMode of CSI reports is set to ‘Mode2’, the UE 402 determines the PUCCH resource and a number of PRBs for the PUCCH resource or a number of Part 2 CSI reports assuming that each CRI in the CSI report is associated with a resource pair.

Additional or alternative aspects of the UE procedure for reporting multiple UCI types are described in [TS38213] § 9.2.5.

### 1.5.2. Adaptation of Cell Operation

A UE 402 configured for operation on a serving cell according to one or both of a cell DTX operation by cellDTXConfig and a cell DRX operation by cellDRXConfig for the serving cell [TS38331], can be additionally provided by dci-Format2-9 a Type3-PDCCH CSS set to monitor PDCCH for detection of DCI format 2_9 as described in [TS38213] § 10.1, and a location in DCI format 2_9 by position-inDCI-NES of a cell DTX/DRX indicator field for the serving cell if the UE 402 is configured with both cell DTX operation and cell DRX operation for the serving cell, the cell DTX/DRX indicator field includes two bits where the first bit indicates the cell DTX operation and the second bit indicates the cell DRX operation; if the UE 402 is configured with only one of the cell DTX operation and cell DRX operation for the serving cell, the cell DTX/DRX indicator field includes one bit indicating one of the cell DTX operation and cell DRX operation, respectively, for the serving cell; a ‘0’ value for a bit of the cell DTX/DRX indicator field indicates deactivation of cell DTX or of cell DRX; a ‘1’ value for a bit of the cell DTX/DRX indicator field indicates activation of cell DTX or of cell DRX; and/or if the serving cell is configured with a SUL carrier, the cell DTX/DRX indicator field indication for activation or deactivation of cell DRX applies to both the UL carrier and the SUL carrier. A UE 402 does not expect to monitor PDCCH for detection of DCI format 2_9 on more than one serving cells. Additional or alternative aspects of adaptation of cell operation are described in [TS38213] § 11.5.

### 1.6. UE Procedure for Reporting Csi

### 1.6.1. Channel State Information Framework

The procedures on aperiodic CSI reporting can be triggered by DCI formats 0_1, DCI format 0_2, and/or DCI format 0_3. The time and frequency resources that can be used by a UE 402 to report CSI are controlled by the gNB 414a. CSI can include one or more of channel quality indicator (CQI), precoding matrix indicator (PMI), CSI-RS resource indicator (CRI), SS/PBCH block resource indicator (SSBRI), layer indicator (LI), rank indicator (RI), layer 1 (L1)-RSRP, L1-SINR, CapabilityIndex, and/or time-domain channel properties (TDCP).

For individual CSI components (e.g., CQI, PMI, CRI, SSBRI, LI, RI, L1-RSRP, L1-SINR, CapabilityIndex, TDCP), a UE 402 is configured by higher layers with N≥1 CSI-ReportConfig reporting settings, X≥1 LTM-CSI-ReportConfig reporting settings, M≥1 CSI-ResourceConfig resource settings, and/or Y≥1 LTM-CSI-ResourceConfig resource settings (e.g., where N, X, M, and Y are numbers). Additionally or alternatively, the UE 402 can be configured with one or more (e.g., 2) list(s) of trigger states given by the higher layer parameters CSI-AperiodicTriggerStateList and CSI-SemiPersistentOnPUSCH-TriggerStateList. Each trigger state in CSI-AperiodicTriggerStateList contains a list of associated CSI-ReportConfigs and/or LTM-CSI-ReportConfigs indicating the resource set IDs for channel and optionally for interference, where a resource set for interference is only present for a report setting given by a CSI-ReportConfig and a trigger state additionally contains one or more csi-ReportSubConfigID if the associated CSI-ReportConfig configured with a list of sub-configurations, as described in [TS38214] § 5.2.1.1. Each trigger state in the CSI-SemiPersistentOnPUSCH-TriggerStateList contains one associated CSI-ReportConfig or LTM-CSI-ReportConfig, and a trigger state additionally contains one or more csi-ReportSubConfigID if the associated CSI-ReportConfig is configured with a list of sub-configurations, as described in [TS38214] § 5.2.1.1.

### 1.6.1.1. Reporting Settings

Each Reporting Setting CSI-ReportConfig is associated with a single downlink BWP (indicated by higher layer parameter BWP-Id) given in the associated CSI-ResourceConfig for channel measurement and contains the parameter(s) for one CSI reporting band: codebook configuration including codebook subset restriction, time-domain behavior, frequency granularity for CQI and PMI, measurement restriction configurations, and the CSI-related quantities to be reported by the UE 402 such as the layer indicator (LI), L1-RSRP, L1-SINR, CRI, SSBRI (SSB Resource Indicator), CapabilityIndex and TDCP.

Each Reporting Setting LTM-CSI-ReportConfig is associated with a LTM-CSI-ResourceConfig for channel measurement and contains the parameters(s) for time-domain behavior, the number of cells and the number of reference signals per cell provided by noOfReportedCells, and noOfReportedRSPerCell, respectively, comprising L1 measurement results associated with current special cell (SpCell) by SpCellInclusion.

The time domain behavior of the CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on. The higher layer parameter report Quantity indicates the CSI-related, L1-RSRP-related, L1-SINR-related, CapabilityIndex-related or TDCP-related quantities to report. The reportFreqConfiguration indicates the reporting granularity in the frequency domain, including the CSI reporting band and if PMI/CQI reporting is wideband or sub-band. The timeRestrictionForChannelMeasurements parameter in CSI-ReportConfig can be configured to enable time domain restriction for channel measurements and timeRestrictionForInterferenceMeasurements can be configured to enable time domain restriction for interference measurements. The CSI-ReportConfig can also contain CodebookConfig, which contains configuration parameters for Type-I, Type II, Enhanced Type II CSI, Further Enhanced Type II Port Selection, Enhanced Type II for coherent joint transmission (CJT), Further Enhanced Type II Port Selection for CJT, Enhanced Type II for predicted PMI, or Further Enhanced Type II Port Selection for predicted PMI including codebook subset restriction when applicable, and configurations of group-based reporting. A UE 402 is not expected to be configured with a CSI report setting associated with a dormant DL BWP if the reportConfigType is set to ‘aperiodic’. A CSI-ReportConfig can contain a list of sub-configurations, provided by the higher layer parameter csi-ReportSubConfigList, where each sub-configuration is identified by csi-ReportSubConfigID and corresponds to a list of one or more CSI-RS resources or corresponds to a CSI-RS antenna port subset, and/or corresponds to a power offset for PDSCH relative to CSI-RS and/or additional to powerControlOffset of the CSI-RS resource(s). In some implementations, a UE 402 is not expected to be configured with a CSI-ReportConfig that contains a mix of sub-configuration(s) each corresponding to a list of one or more CSI-RS resources and some other sub-configuration(s) each corresponding to CSI-RS antenna port subset.

The time domain behavior of LTM-CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on.

### 1.6.1.2. Reporting Configurations

The UE 402 calculates CSI parameters (if reported) assuming the following dependencies between CSI parameters (if reported): LI is calculated conditioned on the reported CQI, PMI, RI and CRI; CQI is calculated conditioned on the reported PMI, RI and CRI; PMI is calculated conditioned on the reported RI and CRI; and/or RI is calculated conditioned on the reported CRI.

The reporting configuration for CSI can be aperiodic (using PUSCH), periodic (using PUCCH) or semi-persistent (using PUCCH, and DCI activated PUSCH). The CSI-RS Resources can be periodic, semi-persistent, or aperiodic. Table 5.2.1.4-1 in [TS38214] shows the supported combinations of CSI reporting configurations and CSI-RS resource configurations and how the CSI reporting is triggered for each CSI-RS resource configuration. Periodic CSI-RS is configured by higher layers. Semi-persistent CSI-RS is activated and deactivated as described in [TS38214] § 5.2.1.5.2. Aperiodic CSI-RS is configured and triggered/activated as described in [TS38214] § 5.2.1.5.1.

### 1.6.1.2.1. Report Quantity Configurations

A UE 402 may be configured with a CSI-ReportConfig with the higher layer parameter report Quantity set to either ‘none’, ‘cri-RI-PMI-CQI’, ‘cri-RI-i1’, ‘cri-RI-i1-CQI’, ‘cri-RI-CQI’, ‘cri-RSRP’, ‘cri-SINR’, ‘ssb-Index-RSRP’, ‘ssb-Index-SINR’, ‘cri-RI-LI-PMI-CQI’, ‘cri-RSRP-Index’, ‘ssb-Index-RSRP-Index’, ‘cri-SINR-Index’, ‘ssb-Index-SINR-Index’ or ‘tdcp’. If the UE 402 is configured with a CSI-ReportConfig with the higher layer parameter reportQuantity set to any of the aforementioned values/parameters, the UE 402 reports a quantity for the CSI-ReportConfig as described in [TS38214].

If the UE 402 is configured with a CSI-ReportConfig that contains a list of sub-configurations, provided by the higher layer parameter [csi-ReportSubConfigList]:
the UE 402 expects to be configured with the higher layer parameter codebookType set to ‘typel-SinglePanel’ or ‘typel-MultiPanel’. If the UE 402 indicates a capability for supporting mixed codebook combination in a slot with [ABC], each sub-configuration can be configured with the higher layer parameter codebookType set to ‘typel-SinglePanel’ or ‘typel-MultiPanel’.

Each sub-configuration can be configured with an antenna port subset using the higher layer bitmap parameter [port-subsetIndicator] which contains the bit sequence p₀, p₁, . . . , p_{Pm-1}, where p₀ is the MSB and p_{Pm-1} is the LSB, bit pᵢ corresponds to antenna port 3000+i, and Pm is the number of ports nrofPorts configured for the CSI-RS resources(s) within the NZP-CSI-RS-ResourceSet contained in the CSI-ResourceConfig for channel measurement that corresponds to the CSI-ReportConfig. A bit value 0 in [port-subsetIndicator] indicates that the corresponding antenna port is disabled for the sub-configuration, whereas bit value 1 indicates that the antenna port is enabled and belongs to the antenna port subset for the sub-configuration. For the derivation of PMI, antenna ports corresponding to all bits with value of 1 in [port-subsetIndicator] are mapped to consecutive antenna ports starting at CSI-RS antenna port 3000 in increasing order of the bit position in [port-subsetIndicator].

If a sub-configuration is configured with an antenna port subset, then the sub-configuration can be configured with a [RI restriction parameter] and, if the number of antenna ports of the subset greater than 2, with [n1-n2 parameter] if the higher layer parameter codebookType is set to ‘typel-SinglePanel’ or with [ng-n1-n2 parameter] if the higher layer parameter codebookType is set to ‘typel-MultiPanel’, and, if the corresponding number of antenna ports of the subset is 2, with twoTX-CodebookSubsetRestriction, where the parameters [RI restriction], [n1-n2], [ng-n1-n2], twoTX-CodebookSubsetRestriction are as described in [TS38214] §§ 5.2.2.2.1 and 5.2.2.2.2.

A sub-configuration can be configured with a list of NZP CSI-RS resources, provided by [nzp-CSI-RS-resourceList], which indicates one or more NZP CSI-RS resources, within the NZP-CSI-RS-ResourceSet contained in the CSI-ResourceConfig for channel measurement which corresponds to the CSI-ReportConfig.

The list of NZP CSI-RS resources is identical to or has no intersection with a list of NZP CSI-RS resources configured for any other sub-configuration(s) within the CSI-ReportConfig. A sub-configuration can be configured with a power offset provided by [powerOffset]. If a sub-configurations is not configured with [nzp-CSI-RS-resourceList] then the sub-configuration is associated with all the NZP CSI-RS resources within the NZP-CSI-RS-ResourceSet contained in the CSI-ResourceConfig for channel measurement which corresponds to the CSI-ReportConfig. The UE 402 reports CSI(s) for one or more sub-configurations according to [TS38214] §§ 5.2.1.5.1, 5.2.1.5.2, 5.2.3 and 5.2.4, and according to the higher layer parameter reportQuantity configured for that CSI-ReportConfig. The UE 402 does not expect the higher layer parameter reportQuantity to be set to ‘cri-RSRP’, ‘cri-SINR’, or ‘cri-SINR-Index’. If the UE 402 is configured with a CSI-ReportConfig with the higher layer parameter reportQuantity set to ‘ssb-Index-RSRP’ or ‘ssb-Index-RSRP-Index’, the UE 402 reports SSBRI, where SSBRI k (k≥0) corresponds to the configured (k+1)-th entry of the associated csi-SSB-ResourceList in the corresponding CSI-SSB-ResourceSet.

### 1.6.1.3. Channel Quality Indicator (CQI)

The CQI indices and their interpretations are given in tables 5.2.2.1-2, 5.2.2.1-3, 5.2.2.1-4, and/or 5.2.2.1-5 in [TS38214] for reporting CQI based on different modulation schemes (e.g., QPSK, 16QAM, 64QAM, 256QAM, and/or 1024 QAM).

Based on an unrestricted observation interval in time unless specified otherwise herein and/or in [TS38214] § 5.2.2.1, and an unrestricted observation interval in frequency, the UE 402 derives for each CQI value reported in uplink slot n the highest CQI index which satisfies the following condition: A single PDSCH transport block with a combination of modulation scheme, target code rate and transport block size corresponding to the CQI index, and occupying a group of downlink physical resource blocks termed the CSI reference resource, could be received with a transport block error probability not exceeding: 0.1, if the higher layer parameter cqi-Table in CSI-ReportConfig configures ‘table1’ (corresponding to table 5.2.2.1-2 in [TS38214]), or ‘table2’ (corresponding to table 5.2.2.1-3 in [TS38214]), or if the higher layer parameter cqi-Table in CSI-ReportConfig configures ‘table4-r17’ (corresponding to table 5.2.2.1-5 in [TS38214]), or 0.00001, if the higher layer parameter cqi-Table in CSI-ReportConfig configures ‘table3’ (corresponding to table 5.2.2.1-4 in [TS38214]).

If the higher layer parameter timeRestrictionForChannelMeasurements is set to “notConfigured”, the UE 402 derives the channel measurements for computing CSI value reported in uplink slot n based on only the NZP CSI-RS, no later than the CSI reference resource (see e.g., [TS38211]), associated with the CSI resource setting. If the higher layer parameter timeRestrictionForChannelMeasurements in CSI-ReportConfig is set to “Configured”, the UE 402 derives the channel measurements for computing CSI reported in uplink slot n based on only the most recent, no later than the CSI reference resource, in cell DTX active time if cell DTX is activated, occasion of NZP CSI-RS (defined in [TS38211]) associated with the CSI resource setting.

If the higher layer parameter timeRestrictionForInterferenceMeasurements is set to “notConfigured”, the UE 402 derives the interference measurements for computing CSI value reported in uplink slot n based on only the CSI-IM and/or NZP CSI-RS for interference measurement no later than the CSI reference resource associated with the CSI resource setting. If the higher layer parameter timeRestrictionForInterferenceMeasurements in CSI-ReportConfig is set to “Configured”, the UE 402 derives the interference measurements for computing the CSI value reported in uplink slot n based on the most recent, no later than the CSI reference resource, in cell DTX active time if cell DTX is activated, occasion of CSI-IM and/or NZP CSI-RS for interference measurement (defined in [TS38211]) associated with the CSI resource setting.

### 1.6.1.3.1. UE Assumptions for CQI/PMI/RI Calculation

If configured to report CQI index, in the CSI reference resource, a UE 402 assumes various conditions, criteria, parameters, and/or other aspects discussed in [TS38214] § 5.2.2.5.1 for the purpose of deriving the CQI index, and if also configured, for deriving PMI and RI. In addition to these aspects, the UE 402 can additionally or alternatively assume the following for the purpose of deriving the CQI index, and if also configured, for deriving PMI and RI:

For a UE 402 configured with a CSI-ReportConfig that contains a list of sub-configurations provided by the higher layer parameter csi-ReportSubConfigList, if a sub-configuration indicates a CSI-RS antenna port subset using the higher layer bitmap parameter [port-subsetIndicator], as described in section 1.6.1.2.1 supra and/or in [TS38214] § 5.2.1.4.2, for CQI calculation for the sub-configuration with the antenna port subset represented by vector [3000+p⁽⁰⁾, . . . , 3000+p^{(P-1)}]^{T} of size P, where P corresponds to the number of bits with value 1 in the bitmap port-subsetIndicator, the UE 402 should assume that PDSCH signals on antenna ports in the set [1000, . . . , 1000+ν−1] for ν layers would result in signals equivalent to corresponding symbols transmitted on antenna ports [3000+p⁽⁰⁾, . . . , 3000+p^{(P-1)}]^{T}, as given by:

$$[ \begin{matrix}{y}^{( 3000 + {p}^{( 0 )} )} ( i ) \\ … \\ {y}^{( 3000 + {p}^{( P - 1 )} )} ( i )\end{matrix} ] = W ( i ) [ \begin{matrix}{x}^{( 0 )} ( i ) \\ … \\ {x}^{( v - 1 )} ( i )\end{matrix} ]$$

where p^{(j)}∈[0, . . . , 31] corresponds to the j-th enabled port in the bitmap [port-subsetIndicator], with p^{(j)}<p^{(j+1)}, j=0, . . . , P−1, and x(i)=[x⁽⁰⁾(i) . . . x^{(v-1)}(i)], and W(i) are as previously described in this section/clause, and the corresponding PDSCH EPRE to CSI-RS EPRE is as previously defined in this section/clause if the sub-configuration does not indicate a power offset powerOffset.

Additionally or alternatively, if a sub-configuration indicates a list of NZP CSI-RS resources, provided by nzp-CSI-RS-resourceList and does not indicate a power offset powerOffset, for CQI calculation for the sub-configuration the UE 402 follows the procedure previously described in this section/clause and/or as described in [TS38214] § 5.2.2.5.1.

Additionally or alternatively, if a sub-configuration indicates a power offset powerOffset, for CQI calculation, the UE 402 assumes the corresponding PDSCH signals transmitted on the antenna ports of a CSI-RS resource would have a ratio of EPRE to CSI-RS EPRE equal to the difference between powerControlOffset of the CSI-RS resource, given in [TS38214] § 5.2.2.3.1, and powerOffset, where the difference is expected to take one of the values that can be configured for powerControlOffset of the CSI-RS resource, given in [TS38214] § 5.2.2.3.1, and is also expected to take a value that is no larger than the value of powerControlOffset.

### 1.6.1.4. CSI Reference Resource Definition

The CSI reference resource for a serving cell is defined in [TS38214] § 5.2.2.5. In addition to the CSI reference resource aspects described by [TS38214] § 5.2.2.5, for the CSI report configuration in CSI-ReportConfig associated with the higher layer parameter reportQuantity comprising at least ‘RI’, the UE 402 configured with cell DTX reports a CSI report only if receiving at least one CSI-RS transmission occasion of each periodic CSI-RS resource or semi-persistent CSI-RS resource for channel measurement and/or interference measurement in active periods of cell DTX no later than CSI reference resource, and the UE 402 configured with cell DTX drops the CSI report otherwise.

### 1.6.2. CSI Reporting Using Pusch

A UE 402 performs aperiodic CSI reporting using PUSCH on serving cell c upon successful decoding of a DCI format 0_1 or DCI format 0_2 which triggers an aperiodic CSI trigger state. A UE 402 performs aperiodic CSI reporting using PUSCH on the serving cell with the smallest serving cell index scheduled by DCI format 0_3 which triggers an aperiodic CSI trigger state. Additional aspects of aperiodic CSI reporting using PUSCH are discussed in [TS38214] § 5.2.3.

A UE 402 performs semi-persistent CSI reporting on the PUSCH upon successful decoding of a DCI format 0_1 or DCI format 0_2 which activates a semi-persistent CSI trigger state. DCI format 0_1 and DCI format 0_2 contains a CSI request field which indicates the semi-persistent CSI trigger state to activate or deactivate. Semi-persistent CSI reporting on the PUSCH supports Type I, Type II with wideband, and sub-band frequency granularities, Enhanced Type II, Further Enhanced Type II Port Selection CSI, Enhanced Type II for CJT, Further Enhanced Type II Port Selection for CJT, Enhanced Type II for predicted PMI and Further Enhanced Type II Port Selection for predicted PMI. The PUSCH resources and MCS are allocated semi-persistently by UL DCI. Additional aspects of semi-persistent CSI reporting using PUSCH are discussed in [TS38214] § 5.2.3.

When CSI reporting on PUSCH comprises two parts, the UE 402 may omit a portion of the Part 2 CSI. Omission of Part 2 CSI is according to the priority order shown in Table 5.2.3-1, where N_{Rep} is the number of CSI reports configured to be carried on the PUSCH. Priority 0 is the highest priority and priority 2N_{Rep} is the lowest priority and the CSI report n corresponds to the CSI report with the nth smallest Pri_{i,CSI}(y,k,c,s) value among the N_{Rep} CSI reports as defined in [TS38214] § 5.2.5. The subbands for a given CSI report n indicated by the higher layer parameter csi-ReportingBand with value ‘1’ are numbered continuously in increasing order with the lowest subband of csi-ReportingBand with value set to ‘1’ as subband 0. When omitting Part 2 CSI information for a particular priority level, the UE 402 omits some or all of the information at that priority level, except when the corresponding CSI report contains one or more Part 2 CSIs each of which corresponding to a sub-configuration from a list of sub-configurations contained in the CSI-ReportConfig as described in [TS38214] § 5.2.1.1.

### 1.6.3. CSI Reporting Using Pucch

A UE 402 is semi-statically configured by higher layers to perform periodic CSI Reporting on the PUCCH. A UE 402 can be configured by higher layers for multiple periodic CSI Reports corresponding to multiple higher layer configured CSI Reporting Settings, where the associated CSI Resource Settings are higher layer configured. For a Reporting Setting for which the CSI-ReportConfig contains a list of sub-configurations provided by the higher layer parameter [csi-ReportSubConfigList], CSI reporting is provided for all the sub-configurations in each corresponding reporting instance. Periodic CSI reporting on PUCCH formats 2, 3, 4 supports Type I CSI with wideband granularity.

A UE 402 performs semi-persistent CSI reporting on the PUCCH applied starting from the first slot that is after slot

$$n + 3 {N}_{slot}^{subframe , μ}$$

when the UE 402 would transmit a PUCCH with HARQ-ACK information in slot n corresponding to the PDSCH carrying the activation command described in [TS38321] § 6.1.3.16 where u is the SCS configuration for the PUCCH. The activation command will contain one or more Reporting Settings, with or without containing one or more sub-configurations for each Reporting Setting for which the CSI-ReportConfig contains a list of sub-configurations provided by the higher layer parameter csi-ReportSubConfigList, where the associated CSI Resource Settings are configured. Semi-persistent CSI reporting on the PUCCH supports Type I CSI. Semi-persistent CSI reporting on the PUCCH format 2 supports Type I CSI with wideband frequency granularity. Semi-persistent CSI reporting on PUCCH formats 3 or 4 supports Type I CSI with wideband and sub-band frequency granularities and Type II CSI Part 1.

In some example implementations, up to four (4) CSI report configurations can be configured in a BWP for semi-persistent (SP) CSI reporting on PUCCH where one or more report configurations can contain a list of sub-configuration(s). Additionally or alternatively, the maximum number of sub-configurations (Lₘₐₓ) in one CSI report configuration is no larger than eight (8) for semi-persistent CSI reporting on PUCCH. Additionally or alternatively, for a report of N CSI(s) in one SP-CSI report, where each CSI corresponds to one sub-configuration, the maximum value of N is no larger than four (4) for semi-persistent CSI reporting on PUCCH.

Additionally or alternatively, a new MAC CE can be designed and/or used for activating/deactivating SP CSI report configurations and selecting N out of L subconfigurations for each CSI reportconfiguration. Additionally or alternatively, the new MAC CE can be used to activate/deactivate configuration(s) and/or sub-configuration(s). In some examples, one new bit per sub-configuration is added to activate/deactivate a corresponding configuration or sub-configuration. Additional or alternative aspects of SP CSI reporting are discussed in [TS38214] § 5.2.4.

### 1.6.4. UE CSI Computation Time

When the CSI request field on a DCI triggers a CSI report(s) on PUSCH, the UE 402 provides a valid CSI report for the n-th triggered report, if the first uplink symbol to carry the corresponding CSI report(s) including the effect of the timing advance, starts no earlier than at symbol Z_{ref}, and if the first uplink symbol to carry the n-th CSI report including the effect of the timing advance, starts no earlier than at symbol Z′_{ref}(n), where Z_{ref} is defined as the next uplink symbol with its CP starting T_{proc,CSI}=(Z)(2048+144)·κ2^{-μ}·T_{C}+T_{switch} after the end of the last symbol of the PDCCH triggering the CSI report(s), and where Z′_{ref}(n), is defined as the next uplink symbol with its CP starting T′_{proc,CSI}=(Z′)(2048+144)·κ2^{-μ}·T_{C} after the end of the last symbol in time of the latest of: aperiodic CSI-RS resource for channel measurements, aperiodic CSI-IM used for interference measurements, and aperiodic NZP CSI-RS for interference measurement, when aperiodic CSI-RS is used for channel measurement for the n-th triggered CSI report, and where T_{switch} is defined in [TS38214] § 6.4 and is applied only if Z₁ of table 5.4-1 in [TS38214] is applied. Additional aspects related to PUSCH indicated by DCI and/or the CSI request field on a DCI are discussed in [TS38214].

Z, Z′ and μ are defined as:

$$Z = {max}_{m = 0 , ... , M - 1} ( Z ( m ) ) and {Z}^{′} = {max}_{m = 0 , ... , M - 1} ( {Z}^{′} ( m ) ) ,$$

where M is the number of updated CSI report(s) according to [TS38214] § 5.2.1.6, (Z(m),Z′(m)) corresponds to the m-th updated CSI report and is defined as discussed in [TS38214] § 5.4. Additionally or alternatively, μ of table 5.4-1 in [TS38214] and table 5.4-2 in [TS38214] and/or as shown below corresponds to the min (μ_{PDCCH},μ_{CSI-RS},μ_{UL}) where the μ_{PDCCH} corresponds to the subcarrier spacing of the PDCCH with which the DCI was transmitted and μ_{UL} corresponds to the subcarrier spacing of the PUSCH with which the CSI report is to be transmitted and μ_{CSI-RS} corresponds to the minimum subcarrier spacing of the aperiodic CSI-RS triggered by the DCI.

TABLE 5.4-2
CSI computation delay requirement 2

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₀ |
| 1 | 33 | 30 | 72 | 69 | 33 | X₁ |
| 2 | 44 | 42 | 141 | 140 | min(44, X₂ + KB₁) | X₂ |
| 3 | 97 | 85 | 152 | 140 | min(97, X₃ + KB₂) | X₃ |
| 5 | 388 | 340 | 608 | 560 | min(388, X₅ + KB3) | X₅ |
| 6 | 776 | 680 | 1216 | 1120 | min(776, X₆ + KB4) | X₆ |

For a CSI report corresponding to a CSI-ReportConfig that contains a list of sub-configurations, provided by the higher layer parameter [csi-ReportSubConfigList], only (Z₂,

$${Z}_{2}^{′} )$$

of table 5.4-2 (supra) and/or table 5.4-2 in [TS38214] is applicable. For a CSI report config containing sub-configuration(s), support (Z₂,

$${Z}_{2}^{′} )$$

in table 5.4-2 in [TS38214] for CSI computation delay requirements. For CPU occupation and update, if there are not enough CPUs for processing the entire CSI report, legacy UE 402 behavior is used. In some implementations, only Z₂,

$${Z}_{2}^{′}$$

will be supported.

### 2. Cellular Network Aspects

FIG. 4 depicts an example network architecture 400. The network 400 may operate in a manner consistent with 3GPP technical specifications for LTE or 5G/NR systems. However, the example embodiments are not limited in this regard and the described examples may apply to other networks that benefit from the principles described herein, such as future 3GPP systems, or the like.

The network 400 includes a UE 402, which is any mobile or non-mobile computing device designed to communicate with a RAN 404 via an over-the-air (OTA) connection. The UE 402 is communicatively coupled with the RAN 404 by a Uu interface. Examples of the UE 402 include, but are not limited to, a smartphone, tablet computer, wearable device (e.g., smart watch, fitness tracker, smart glasses, smart clothing/fabrics, head-mounted displays, smart shows, and/or the like), desktop computer, workstation, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, Internet of Things (IoT) device, smart appliance, unmanned aerial vehicle (UAV), drone, robot (semi-)autonomous vehicle, electronic signage, single-board computer, plug computers, and/or any other type of computing device, such as any of those discussed herein.

In some examples, the network 400 includes a set of UEs 402 coupled directly with one another via a sidelink (SL) interface, which involves communication between two or more UEs 402 using 3GPP technology without traversing a network node. Here, the SL interface includes, for example, one or more SL logical channels (e.g., sidelink broadcast control channel (SBCCH), sidelink control channel (SCCH), and sidelink traffic channel (STCH)); one or more SL transport channels (e.g., sidelink shared channel (SL-SCH) and sidelink broadcast channel (SL-BCH)); and one or more SL physical channels (e.g., physical sidelink shared channel (PSSCH), physical sidelink control channel (PSCCH), physical sidelink Feedback channel (PSFCH), physical sidelink broadcast channel (PSBCH), and/or the like). The UE 402 may perform blind decoding attempts of SL channels/links according to the various examples herein.

In some examples, the UE 402 can communicate with an access point (AP) 406 via an OTA connection. The AP 406 manages a WLAN connection between the UE 402 and the AP 406, which is consistent with any IEEE 802 protocol. Additionally, the UE 402, RAN 404, and AP 406 may utilize cellular-WLAN aggregation/integration (e.g., LWA/LWIP), which may serve to offload some/all network traffic from the RAN 404.

The RAN 404 includes one or more network access nodes (NANs) 414 (also referred to as “access network nodes” and/or the like). The NANs 414 terminate air-interface(s) for the UE 402 by providing access stratum protocols including RRC, PDCP, RLC, MAC, and PHY/L1 protocols. In this manner, the NANs 414 enable data/voice connectivity between the CN 440 and the UE 402. The NANs 414 may be a macrocell base station or a low power base station for providing femtocells, picocells or other like cells having smaller coverage areas, smaller user capacity, or higher bandwidth compared to macrocells; or some combination thereof. In these implementations, an NAN 414 be referred to as a BS, gNB, RAN node, eNB, ng-eNB, NodeB, RSU, TRP, and the like. The RAN 404 may have an NG-RAN architecture as discussed in 3GPP TS 38.401.

The RAN 404 (or individual NANs 414) may provide the air interface over a licensed spectrum or an unlicensed spectrum. To operate in the unlicensed spectrum, the nodes may use LAA, eLAA, and/or feLAA mechanisms based on CA technology with PCells/SCells. Prior to accessing the unlicensed spectrum, the nodes may perform medium/carrier-sensing operations based on, for example, a listen-before-talk (LBT) protocol.

The set of NANs 414 are coupled with one another via respective Xn interfaces if the RAN 404. The Xn interfaces, which may be separated into control/user plane interfaces in some examples, allow the NANs 414 to communicate information related to handovers, data/context transfers, mobility, load management, interference coordination, and the like. The NANs 414 manage one or more cells, cell groups, component carriers (CCs), and the like to provide the UE 402 with an air interface for network access. The UE 402 may be simultaneously connected with a set of cells provided by the same or different NANs 414 of the RAN 404 or a different RAN 404. For example, the UE 402 and RAN 404 may use carrier aggregation (CA) to allow the UE 402 to connect with a set of CCs, each corresponding to a primary cell (PCell) or secondary cell (SCell). The NG-RAN 404 supports multi-radio DC (MR-DC) operation where a UE 402 is configured to utilize radio resources provided by two distinct schedulers, located in at least two different NG-RAN nodes 414 connected via a non-ideal backhaul, one NG-RAN node 414 providing NR access and the other NG-RAN node 414 providing either E-UTRA or NR access. Further details of MR-DC operation, including conditional PSCell addition (CPA) and conditional PSCell change (CPC), can be found in 3GPP TS 36.300 (“[TS36300]”), [TS38300], and 3GPP TS 37.340.

Individual UEs 402 can be configured to measure or collect radio information, and provide the radio information to one or more NANs 414. The radio information may be in the form of one or more measurement reports, and/or may include, for example, signal strength measurements, signal quality measurements, and/or the like. Each measurement report can be tagged with a timestamp and the location of the measurement (e.g., the UEs 402 current location). For example, the UE 402 can perform reference signal (RS) measurement and reporting procedures to provide the network with information about the quality of one or more wireless channels and/or the communication media in general, and this information can be used to optimize various aspects of the communication system. As examples, the measurement and reporting procedures performed by the UE 402 can include those discussed in [TS38211], [TS38212], [TS38213], [TS38214], 3GPP TS 36.214 (“[TS36214]”), [TS38215], [TS38101-1], [TS38104], [TS38113], [TS38133], [TS38331], and/or other the like. The physical signals and/or reference signals can include demodulation reference signals (DM-RS), phase-tracking reference signals (PT-RS), positioning reference signal (PRS), channel-state information reference signal (CSI-RS), synchronization signal block (SSB), primary synchronization signal (PSS), secondary synchronization signal (SSS), sounding reference signal (SRS), and/or the like. Examples of the measurements performed/collected by individual UEs 402 and/or included in measurement reports can include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (Eb/N0), energy per chip to interference power density ratio (Ec/I0), energy per chip to noise power density ratio (Ec/N0), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames for UE positioning for E-UTRAN or 5G/NR (e.g., a timing between an AP 406 or RAN node 408 reference time and a GNSS-specific reference time for a given GNSS), GNSS code measurements (e.g., the GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g., IEEE 802, IEEE 802.11, IEEE 802.15, IEEE 1609.0, and/or the like) networks. Other measurements may be additionally or alternatively used, such as those discussed in [TS36214], [TS38215], 3GPP TS 38.314 (“[TS38314]”), 3GPP TS 28.552 (“[TS28552]”), 3GPP TS 32.425 (“[TS32425]”), IEEE 802.11, and/or the like. Additionally or alternatively, any of the aforementioned measurements (or combination of measurements) may be collected by one or more NANs 414 and/or other network nodes.

As alluded to previously, the NG-RAN 414 provides a 5G-NR air interface (e.g., Uu interface), which may have the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

Downlink (DL), uplink (UL), and SL transmissions are organized into frames, and individual frames are organized into a set of subframes. A subframe is a time interval during which one or more signals is/are signaled (e.g., transmitted and/or received). In some implementations, each frame is divided into two equally-sized half-frames of five subframes each. The slot duration is 14 symbols with normal cyclic prefix (CP) and 12 symbols with extended CP, and scales in time as a function of the used sub-carrier spacing so that there is always an integer number of slots in a subframe. A time slot (or “slot”) is an integer multiple of consecutive subframes. A timing advance (TA) is used to adjust the UL frame timing relative to the DL frame timing.

In particular, DL, UL, and SL transmissions are organized into frames with T_{f}=(ΔfₘₐₓN_{f}/100)·T_{c}=10 ms duration, each including ten subframes of T_{sf}=(ΔfₘₐₓN_{f}/1000). T_{c}=1 ms duration. The number of consecutive OFDM symbols per subframe is

$${N}_{symb}^{subframe , μ} = {N}_{symb}^{slot} {N}_{slot}^{subframe , μ} .$$

Each frame is divided into two equally-sized half-frames of five subframes each with half-frame 0 including subframes 0-4 and half-frame 1 including subframes 5-9. There is one set of frames in the UL and one set of frames in the DL on a carrier. UL frame number i for transmission from the UE 402 starts

$${T}_{TA} = ( {N}_{TA} + {N}_{TA , offset} + {N}_{TA , adj}^{common} + {N}_{TA , adj}^{UE} ) {T}_{c}$$

before the start of the corresponding downlink frame at the UE where N_{TA} and N_{TA,offset} are given by [TS38213] § 4.2, except for msgA transmission on PUSCH where N_{TA}=0 is used;

$${N}_{TA , adj}^{common}$$

given by [TS38213] § 4.2 is derived from the higher-layer parameters ta-Common, ta-CommonDrift, and ta-CommonDriftVariant if configured, otherwise

$${N}_{TA , adj}^{common} = 0 ; and {N}_{TA , adj}^{UE}$$

given by [TS38213] § 4.2 is computed by the UE based on UE position and serving-satellite-ephemeris-related higher-layers parameters if configured, otherwise

$${N}_{TA , adj}^{UE} = 0.$$

The DL transmission waveform is conventional OFDM using a cyclic prefix (CP). The UL transmission waveform is conventional OFDM using a CP with a transform precoding function performing DFT spreading that can be disabled or enabled. For operation with shared spectrum channel access in frequency range 1 (FR1), the UL transmission waveform subcarrier mapping can map to subcarriers in one or more PRB interlaces. The numerology is based on exponentially scalable SCS Δf=2^{μ}×15 kHz with μ={0,1,3,4,5,6} for PSS, SSS and PBCH and μ={0, 1,2,3,5,6} for other channels. Normal CP is supported for all sub-carrier spacings, extended CP is supported for μ=2. 12 consecutive sub-carriers form a PRB; up to 275 PRBs are supported on a carrier.

For subcarrier spacing (SCS) configuration μ, slots are numbered

$${n}_{s}^{μ} ∈ \{ 0 , ... , {N}_{slot}^{subframe , μ} - 1 \}$$

in increasing order within a subframe and

$${n}_{s , f}^{μ} ∈ \{ 0 , ... , {N}_{slot}^{frame , μ} - 1 \}$$

in increasing order within a frame. There are

$${N}_{symb}^{slot}$$

consecutive OFDM symbols in a slot where

$${N}_{symb}^{slot}$$

depends on the cyclic prefix as given by Tables 4.3.2-1 and 4.3.2-2 of [TS38211]. The start of slot

$${n}_{s}^{μ}$$

in a subframe is aligned in time with the start of OFDM symbol

$${n}_{s}^{μ} {N}_{symb}^{slot}$$

in the same subframe. OFDM symbols in a slot in a DL or UL frame can be classified as ‘downlink’, ‘flexible’, or ‘uplink’. Signaling of slot formats is described in [TS38213] § 11.1. In a slot in a DL frame, the UE 402 assume that downlink transmissions only occur in ‘downlink’ or ‘flexible’ symbols. In a slot in an UL frame, the UE 402 only transmits in ‘uplink’ or ‘flexible’ symbols.

A UE 402 not capable of full-duplex communication and not supporting simultaneous transmission and reception as defined by parameter simultaneousRxTxInterBandENDC, simultaneousRxTxInterBandCA or simultaneousRxTxSUL (see e.g., 3GPP TS 38.306) among all cells within a group of cells is not expected to transmit in the uplink in one cell within the group of cells earlier than N_{Rx-Tx}T_{c} after the end of the last received downlink symbol in the same or different cell within the group of cells where N_{Rx-Tx} is given by Table 4.3.2-3 of [TS38211]. A UE 402 not capable of full-duplex communication and not supporting simultaneous transmission and reception as defined by parameter simultaneousRxTxInterBandENDC, simultaneousRxTxInterBandCA or simultaneousRxTxSUL (see e.g., 3GPP TS 38.306) among all cells within a group of cells is not expected to receive in the downlink in one cell within the group of cells earlier than N_{Tx-Rx}T_{c} after the end of the last transmitted uplink symbol in the same or different cell within the group of cells where N_{Tx-Rx} is given by Table 4.3.2-3 of [TS38211].

For DAPS handover operation, a UE 402 not capable of full-duplex communication is not expected to transmit in the uplink to a cell earlier than N_{Rx-Tx} T_{c} after the end of the last received downlink symbol in the different cell where N_{Rx-Tx} is given by Table 4.3.2-3. For DAPS handover operation, a UE 402 not capable of full-duplex communication is not expected to receive in the downlink from a cell earlier than N_{Tx-Rx} T_{c} after the end of the last transmitted uplink symbol in the different cell where N_{Tx-Rx} is given by Table 4.3.2-3 of [TS38211].

A UE 402 not capable of full-duplex communication is not expected to transmit in the uplink earlier than N_{Rx-Tx}T_{c} after the end of the last received downlink symbol in the same cell where N_{Rx-Tx} is given by Table 4.3.2-3 of [TS38211]. A UE 402 not capable of full-duplex communication is not expected to receive in the downlink earlier than N_{Tx-Rx}T_{c} after the end of the last transmitted uplink symbol in the same cell where N_{Tx-Rx} is given by Table 4.3.2-3 of [TS38211].

An antenna port is defined such that the channel over which a symbol on the antenna port is conveyed can be inferred from the channel over which another symbol on the same antenna port is conveyed. Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

For each numerology and carrier, a resource grid of

$${N}_{grid , x}^{size , μ} {N}_{sc}^{RE}$$

subcarriers and

$${N}_{symb}^{subframe , μ}$$

OFDM symbols is defined, starting at common resource block (CRB)

$${N}_{grid}^{start , μ}$$

indicated by higher-layer signalling. There is one set of resource grids per transmission direction (UL, DL, or SL) with the subscript x set to DL, UL, and SL for downlink, uplink, and sidelink, respectively. When there is no risk for confusion, the subscript x may be dropped. There is one resource grid for a given antenna port p, SCS configuration u, and transmission direction (UL, DL, or SL).

For UL and DL, the carrier bandwidth

$${N}_{grid}^{size , μ}$$

for SCS configuration μ is given by the higher-layer parameter carrierBandwidth in the SCS-SpecificCarrier IE. The starting position

$${N}_{grid}^{start , μ}$$

for SCS configuration μ is given by the higher-layer parameter offsetToCarrier in the SCS-SpecificCarrier IE.

The frequency location of a subcarrier refers to the center frequency of that subcarrier. For the DL, the higher-layer parameter txDirectCurrentLocation in the SCS-SpecificCarrier IE indicates the location of the transmitter DC subcarrier in the downlink for each of the numerologies configured in the downlink. Values in the range 0-3299 represent the number of the DC subcarrier and the value 3300 indicates that the DC subcarrier is located outside the resource grid. For the UL, the higher-layer parameter txDirectCurrentLocation in the UplinkTxDirectCurrentBWP IE indicates the location of the transmitter DC subcarrier in the uplink for each of the configured bandwidth parts (BWPs), including whether the DC subcarrier location is offset by 7.5 kHz relative to the center of the indicated subcarrier or not. Values in the range 0-3299 represent the number of the DC subcarrier, the value 3300 indicates that the DC subcarrier is located outside the resource grid, and the value 3301 indicates that the position of the DC subcarrier in the uplink is undetermined.

Each element in the resource grid for antenna port p and SCS configuration μ is called a resource element and is uniquely identified by (k, l)_{p,μ} where k is the index in the frequency domain and l refers to the symbol position in the time domain relative to some reference point. Resource element (k, l)_{p,μ} corresponds to a physical resource and the complex value

$${a}_{k , l}^{( p , μ )} .$$

When there is no risk for confusion, or no particular antenna port or SCS is specified, the indices p and μ may be dropped, resulting in

$${a}_{k , l}^{( p )}$$

or a_{k,l}. A resource block (RB) is defined as

$${N}_{sc}^{RB} = 12$$

consecutive subcarriers in the frequency domain. Point A serves as a common reference point for resource block grids and is obtained from: offsetToPointA for a PCell downlink where offsetToPointA represents the frequency offset between point A and the lowest subcarrier of the lowest resource block, which overlaps with the SS/PBCH block used by the UE 402 for initial cell selection, expressed in units of resource blocks assuming 15 kHz SCS for FR1 and 60 kHz SCS for FR2; for operation without shared spectrum channel access in FR1 and FR2-1, the lowest resource block has the SCS provided by the higher layer parameter subCarrierSpacingCommon; for operation with shared spectrum channel access in FRI or FR2, and for operation without shared spectrum channel access in FR2-2, the lowest resource block has the SCS same as the SS/PBCH block used by the UE 402 for initial cell selection; absoluteFrequencyPointA for all other cases where absoluteFrequencyPointA represents the frequency-location of point A expressed as in ARFCN.

CRBs are numbered from 0 and upwards in the frequency domain for SCS configuration μ. The center of subcarrier 0 of CRB 0 for SCS configuration u coincides with ‘point A’. The relation between the CRB number

$${n}_{CRB}^{μ}$$

in the frequency domain and resource elements (k, l) for SCS configuration μ is given by

$${n}_{CRB}^{μ} = ⌊ \frac{k}{{N}_{sc}^{RB}} ⌋ ,$$

where k is defined relative to point A such that k=0 corresponds to the subcarrier centered around point A. Physical resource blocks (PRBs) for SCS configuration μ are defined within a BWP and numbered from 0 to

$${N}_{BWP , i}^{size , μ} - 1$$

where i is the number of the BWP. The relation between the physical resource block

$${n}_{PRB}^{μ}$$

### is BWP i and the CRB

$${n}_{CRB}^{μ}$$

is given by

$${n}_{CRB}^{μ} = {n}_{PRB}^{μ} + {N}_{BWP , i}^{start , μ}$$

where

$${N}_{BWP , i}^{start , μ}$$

is the CRB where BWP i starts relative to CRB 0. When there is no risk for confusion the index μ may be dropped. Virtual resource blocks (VRBs) are defined within a BWP and numbered from 0 to

$${N}_{BWP , i}^{start} - 1$$

where i is the number of the BWP. Multiple interlaces of resource blocks are defined where interlace m∈{0, 1, . . . , M−1} consists of CRBs {m, M+m, 2M+m, 3M+m, . . . }, with M being the number of interlaces given by Table 4.4.4.6-1. The relation between the interlaced resource block

$${n}_{IRB , m}^{μ}$$

∈{0,1, . . . } in BWP i and interlace m and the

$$CRB {n}_{CRB}^{μ}$$

is given by:

$${n}_{CRB}^{μ} = {Mn}_{IRB , m}^{μ} + {N}_{BWP , i}^{start , μ} + ( ( m - {N}_{BWP , i}^{start , μ} ) mod M ) ,$$

where

$${N}_{BWP , i}^{start , μ}$$

is the CRB where BWP starts relative to CRB 0. When there is no risk for confusion the index μ may be dropped. The UE 402 expects that the number of CRBs in an interlace contained within BWP i is no less than 10.

The UE 402 may be configured with one or more bandwidth parts (BWPs) on a given CC, of which only one can be active at a time, as described in [TS38300] §§ 7.8 and 6.10, respectively. The active BWP defines the UE's 402 operating bandwidth within the cell's operating bandwidth. For initial access, and until the UE's 402 configuration in a cell is received, initial bandwidth part detected from system information is used. The 5G-NR air interface may utilize BWPs for various purposes. For example, BWP can be used for dynamic adaptation of the SCS. For example, the UE 402 can be configured with multiple BWPs where each BWP configuration has a different SCS. When a BWP change is indicated to the UE 402, the SCS of the transmission is changed as well. Another use case example of BWP is related to power saving. In particular, multiple BWPs can be configured for the UE 402 with different amount of frequency resources (e.g., PRBs) to support data transmission under different traffic loading scenarios. A BWP containing a smaller number of PRBs can be used for data transmission with small traffic load while allowing power saving at the UE 402 and in some cases at the gNB 416. A BWP containing a larger number of PRBs can be used for scenarios with higher traffic load. A BWP is a subset of contiguous CRBs defined in [TS38211] § 4.4.4.3 for a given numerology μᵢ in BWP i on a given carrier. The starting position

$${N}_{BWP , i}^{start , μ}$$

and the number of resource blocks

$${N}_{BWP , i}^{size , μ}$$

in a BWP fulfills

$${N}_{grid , x}^{start , μ} \leq {N}_{BWP , i}^{start , μ} < {N}_{grid , x}^{start , μ} + {N}_{grid , x}^{size , μ} and {N}_{grid , x}^{start , μ} < {N}_{BWP , i}^{start , μ} + {N}_{BWP , i}^{size , μ} \leq {N}_{grid , x}^{start , μ} + {N}_{grid , x}^{size , μ} ,$$

respectively. Configuration of a BWP is described in [TS38213] § 12. A UE 402 can be configured with up to four BWPs in the DL with a single downlink BWP being active at a given time. The UE 402 is not expected to receive PDSCH, PDCCH, or CSI-RS (except for RRM) outside an active BWP. A UE 402 can be configured with up to four BWPs in the UL with a single uplink BWP being active at a given time. If a UE 402 is configured with a supplementary uplink, the UE can in addition be configured with up to four BWPs in the supplementary uplink with a single supplementary uplink BWP being active at a given time. The UE does not transmit PUSCH or PUCCH outside an active BWP. For an active cell, the UE 402 does not transmit SRS outside an active BWP. Unless otherwise noted, the description in this specification applies to each of the BWPs. When there is no risk of confusion, the index μ may be dropped from

$${N}_{BWP , i}^{start , μ} , {N}_{BWP , i}^{size , μ} , {N}_{grid , x}^{start , μ} , and {N}_{grid , x}^{size , μ} .$$

W.r.t CA, transmissions in multiple cells can be aggregated. Unless otherwise noted, the description in this specification applies to each of the serving cells. For CA of cells with unaligned frame boundaries, the slot offset

$${N}_{slot , offset}^{CA}$$

between a PCell/Primary SCell (PSCell) and an SCell is determined by higher-layer parameter ca-SlotOffset for the SCell. The quantity μ_{offset} is defined as the maximum of the lowest SCS configuration among the SCSs given by the higher-layer parameters scs-SpecificCarrierList configured for PCell/PSCell and the SCell, respectively. The slot offset

$${N}_{slot , offset}^{CA}$$

fulfills when the lowest SCS configuration among the SCSs configured for the cell is μ=2 for both cells or μ=3 for both cells, the start of slot 0 for the cell whose point A has a lower frequency coincides with the start of slot

$${qN}_{slot , offset}^{CA} mod {N}_{slot}^{frame , {μ}_{offset}}$$

for the other cell where q=−1 if point A of the PCell/PSCell has a frequency lower than the frequency of point A for the SCell, otherwise q=1; otherwise, the start of slot 0 for the cell with the lower SCS of the lowest SCS given by the higher-layer parameters scs-SpecificCarrierList configured for the two cells, or the PCell/PSCell if both cells have the same lowest SCS given by the higher-layer parameters scs-SpecificCarrierList configured for the two cells, coincides with the start of slot

$${qN}_{slot , offset}^{CA} mod {N}_{slot}^{frame , {μ}_{offset}}$$

for the other cell where q=−1 if the lowest subcarrier spacing configuration given by scs-SpecificCarrierList of the PCell/PSCell is smaller than or equal to the lowest SCS given by scs-SpecificCarrierList for the SCell, otherwise q=1.

The PDCCH can be used to schedule DL transmissions on PDSCH and UL transmissions on PUSCH, where the DCI on PDCCH includes DL assignments containing at least modulation and coding format, resource allocation, and hybrid-ARQ information related to DL-SCH; and/or UL scheduling grants containing at least modulation and coding format, resource allocation, and hybrid-ARQ information related to UL-SCH. In addition to scheduling, PDCCH can be used to for: activation and deactivation of configured PUSCH transmission with configured grant; activation and deactivation of PDSCH semi-persistent transmission; activation of one or more CSI/measurement configurations and/or triggering CSI/measurement reporting according to the various embodiments discussed herein; notifying one or more UEs 402 of the slot format; notifying one or more UEs 402 of the PRB(s) and OFDM symbol(s) where the UE 402 may assume no transmission is intended for the UE 402; transmission of TPC commands for PUCCH and PUSCH; transmission of one or more TPC commands for SRS transmissions by one or more UEs 402; switching a UE's 402 active BWP; initiating a random access procedure; indicating the UE(s) 402 to monitor the PDCCH during the next occurrence of the DRX on-duration; in IAB context, indicating the availability for soft symbols of an IAB-DU; triggering one shot HARQ-ACK codebook feedback; and for operation with shared spectrum channel access: triggering search space set group switching; indicating one or more UEs 402 about the available RB sets and channel occupancy time duration; and indicating downlink feedback information for configured grant PUSCH (CG-DFI). Polar coding is used for PDCCH. Each RE group carrying PDCCH carries its own DMRS. QPSK modulation is used for PDCCH.

The UE 402 monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. The PDCCH repetition is operated by using two search spaces which are explicitly linked by configuration provided by the RRC layer, and are associated with corresponding CORESETs. For PDCCH repetition, two linked search spaces are configured with the same number of candidates, and two PDCCH candidates in two search spaces are linked with the same candidate index. When PDCCH repetition is scheduled to a UE 402, an intra-slot repetition is allowed and each repetition has the same number of CCEs and coded bits, and corresponds to the same DCI payload.

The PUCCH carries UL control information (UCI) from the UE 402 to the RAN node 414 (e.g., gNB 414a). Five formats of PUCCH exist, depending on the duration of PUCCH and the UCI payload size: Format #0: Short PUCCH of 1 or 2 symbols with small UCI payloads of up to two bits with UE multiplexing capacity of up to 6 UEs with 1-bit payload in the same PRB; Format #1: Long PUCCH of 4-14 symbols with small UCI payloads of up to two bits with UE multiplexing capacity of up to 84 UEs without frequency hopping and 36 UEs with frequency hopping in the same PRB; Format #2: Short PUCCH of 1 or 2 symbols with large UCI payloads of more than two bits with no UE multiplexing capability in the same PRBs; Format #3: Long PUCCH of 4-14 symbols with large UCI payloads with no UE multiplexing capability in the same PRBs; and Format #4: Long PUCCH of 4-14 symbols with moderate UCI payloads with multiplexing capacity of up to 4 UEs 402 in the same PRBs.

The RAN 404 is communicatively coupled to CN 420 that includes network elements and/or network functions (NFs) to provide various functions to support data and telecommunications services to customers/subscribers (e.g., UE 402). The components of the CN 420 may be implemented in one physical node or separate physical nodes. In some examples, NFV may be utilized to virtualize any or all of the functions provided by the network elements of the CN 420 onto physical compute/storage resources in servers, switches, and the like. A logical instantiation of the CN 420 may be referred to as a network slice, and a logical instantiation of a portion of the CN 420 may be referred to as a network sub-slice. In the example of FIG. 4, the CN 440 is a 5GC 440 including an Authentication Server Function (AUSF) 442, Access and Mobility Management Function (AMF) 444, Session Management Function (SMF) 446, User Plane Function (UPF) 448, Network Slice Selection Function (NSSF) 450, Network Exposure Function (NEF) 452, Network Repository Function (NRF) 454, Policy Control Function (PCF) 456, Unified Data Management (UDM) 458, Unified Data Repository (UDR), Application Function (AF) 460, and Network Data Analytics Function (NWDAF) 462 coupled with one another over various interfaces as shown. Various aspects of the various NFs in the 5GC 440 are discussed in detail in '970 and [TS23501], among many other 3GPP standards/specifications. Although not shown by FIG. 4, the system 400 may also include NFs that are not shown such as, for example, any of those discussed in [TS23501]

The data network (DN) 436, at least in some examples, is a network hosting data-centric services such as, for example, operator services, the internet, third-party services, or enterprise networks. In some examples, the DN 436 includes one or more service networks that belong to an operator or third party, which are offered as a service to a client or UE 402. Additionally or alternatively, the DN 436 is provided by one or more servers including, for example, application (app)/content server 438, edge servers and/or edge compute nodes, cloud computing services, and/or the like. The DN 436 may be an operator external public, a private PDN, or an intra-operator packet data network, for example, for provision of IMS services. In this example, the app server 438 can be coupled to an IMS via an S-CSCF or the I-CSCF. In some implementations, the DN 436 may represent one or more local area DNs (LADNs), which are DNs 436 (or DN names (DNNs)) that is/are accessible by a UE 402 in one or more specific areas. Outside of these specific areas, the UE 402 is not able to access the LADN/DN 436. Additionally or alternatively, the DN 436 may be an edge DN 436, which is a (local) DN that supports the architecture for enabling edge applications. In these examples, the app server 438 may represent the physical hardware systems/devices providing app server functionality and/or the application software resident in the cloud or at an edge compute node that performs server function(s). In some examples, the app/content server 438 provides an edge hosting environment that provides support required for Edge Application Server's execution.

In some examples, the 5GS can use one or more edge compute nodes to provide an interface and offload processing of wireless communication traffic. In these examples, the edge compute nodes may be included in, or co-located with one or more RANs 404 or RAN nodes 414. For example, the edge compute nodes can provide a connection between the RAN 404 and UPF 448 in the 5GC 440. The edge compute nodes can use one or more NFV instances instantiated on virtualization infrastructure within the edge compute nodes to process wireless connections to and from the RAN 414 and UPF 448. The edge compute nodes may include or be part of an edge system that employs one or more edge computing technologies (ECTs) (also referred to as an “edge computing framework” or the like). The edge compute nodes may also be referred to as “edge hosts” or “edge servers.” The edge system includes a collection of edge servers and edge management systems (not shown) necessary to run edge computing applications within an operator network or a subset of an operator network. The edge servers are physical computer systems that may include an edge platform and/or virtualization infrastructure, and provide compute, storage, and network resources to edge computing applications. Each of the edge servers are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 402. The VI of the edge compute nodes provide virtualized environments and virtualized resources for the edge hosts, and the edge computing applications may run as VMs and/or application containers on top of the VI. Examples of the edge computing frameworks/ECTs and services deployment examples that can be used are discussed in '970.

The interfaces of the 5GC 440 include reference points and service-based interfaces. A reference point, at least in some examples, is a point at the conjunction of two non-overlapping functional groups, elements, or entities. The reference points in the 5GC 440 include: N1, N2, N3, N4, N5, N6, N7, N8, N9, N10, N11, N12, N13, N14 (between two AMFs 444; not shown), N15, N16, and N22. Other reference points not shown in FIG. 4 can also be used, such as any of those discussed in [TS23501]. The service-based representation of FIG. 4 represents NFs within the control plane that enable other authorized NFs to access their services. A service-based interface (SBI), at least in some examples, is an interface over which an NF can access the services of one or more other NFs. In some implementations, the service-based interfaces are API-based interfaces (e.g., HTTP/2, RESTful, SOAP, and/or any other API or web service) that can be used by an NF to call or invoke a particular service or service operation. The SBIs in the 5GC 440 include: Namf, Nsmf, Nnef, Npcf, Nudm, Naf, Nnrf, Nnssf, Nausf. Other service-based interfaces (e.g., Nudr, N5g-eir, and Nudsf) not shown in FIG. 4 can also be used, such as any of those discussed in [TS23501].

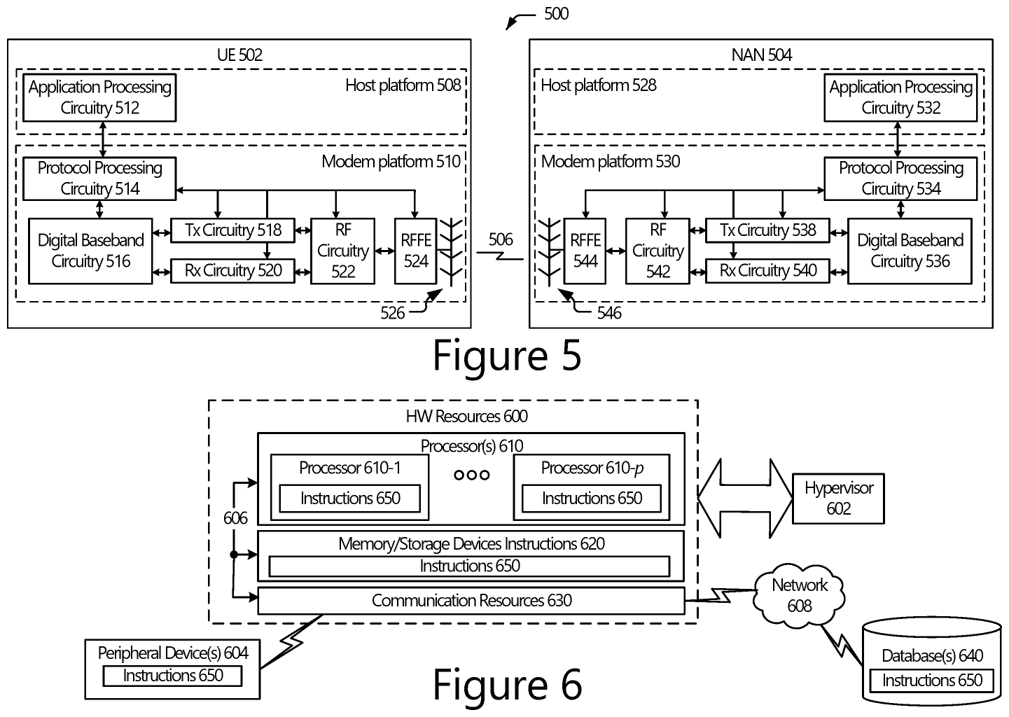

FIG. 5 schematically illustrates a wireless network 500. The wireless network 500 includes a UE 502 in wireless communication with a NAN 504. The UE 402 may be the same or similar to UE 402 of FIGS. 1-4 and NAN 504 may be the same or similar to the RAN node 414 of FIGS. 1-4.

The UE 502 can communicatively couple with the NAN 504 via connection 506. The connection 506 is an air interface to enable communicative coupling, and can be consistent with cellular communications protocols (e.g., LTE, 5G/NR, mmWave or sub-6 GHz frequencies, and/or any other access network protocol). The connection 506 may correspond to the Uu interface described w.r.t FIG. 4.

The UE 502 includes a host platform 508 coupled with a modem platform 510. The host platform 508 includes application processing circuitry 512, which may be coupled with protocol processing circuitry 514 of the modem platform 510. The application processing circuitry 512 may run various applications for the UE 502 that source/sink application data. The application processing circuitry 512 may further implement one or more layer operations to transmit/receive application data to/from a data network. These layer operations includes transport (e.g., UDP, QUIC, TCP, and/or the like) and network (e.g., IP and/or the like) operations. The protocol processing circuitry 514 may implement one or more of layer operations to facilitate transmission or reception of data over the connection 506. The layer operations implemented by the protocol processing circuitry 514 includes, for example, MAC, RLC, PDCP, RRC and NAS operations.

The modem platform 510 may further include digital baseband circuitry 516 that may implement one or more layer operations that are “below” layer operations performed by the protocol processing circuitry 514 in a network protocol stack. These operations includes, for example, PHY operations including one or more of HARQ functions, scrambling/descrambling, encoding/decoding, layer mapping/de-mapping, modulation symbol mapping, received symbol/bit metric determination, multi-antenna port precoding/decoding, which includes one or more of space-time, space-frequency or spatial coding, reference signal generation/detection, preamble sequence generation and/or decoding, synchronization sequence generation/detection, control channel signal blind decoding, and/or other related functions, including any of those discussed herein and/or in 3GPP TS 36.201, 3GPP TS 38.201, [TS38211], [TS38212], [TS38213], [TS38214], and/or any other standards/specifications, including any of those mentioned herein. In some examples, the protocol processing circuitry 514 includes one or more instances of control circuitry (not shown) to provide control functions for the transmit/receive components.

The modem platform 510 includes transmit circuitry 518, receive circuitry 520, RF circuitry 522, and RF front end (RFFE) 524, which includes or connect to one or more antenna panels 526. Briefly, the transmit circuitry 5 518 includes a digital-to-analog converter, mixer, intermediate frequency (IF) components; the receive circuitry 520 includes an analog-to-digital converter, mixer, IF components; the RF circuitry 522 includes a low-noise amplifier, a power amplifier, power tracking components, etc.; RFFE 524 includes filters (for example, surface/bulk acoustic wave filters), switches, antenna tuners, beamforming components (for example, phase-array antenna components), and/or the like. The selection and arrangement of the components of the transmit circuitry 518, receive circuitry 520, RF circuitry 522, RFFE 524, and antenna panels 526 may be specific to details of a specific implementation such as, for example, whether communication is TDM or FDM, in mmWave or sub-6 gHz frequencies, etc. In some examples, the transmit/receive components may be arranged in multiple parallel transmit/receive chains, may be disposed in the same or different chips/modules, etc.

A UE reception may be established by and via the antenna panels 526, RFFE 524, RF circuitry 522, receive circuitry 520, digital baseband circuitry 516, and protocol processing circuitry 514. In some examples, the antenna panels 526 may receive a transmission from the AN 504 by receive-beamforming signals received by a plurality of antennas/antenna elements of the one or more antenna panels 526. A UE transmission may be established by and via the protocol processing circuitry 514, digital baseband circuitry 516, transmit circuitry 518, RF circuitry 522, RFFE 524, and antenna panels 526. In some examples, the transmit components of the UE 504 may apply a spatial filter to the data to be transmitted to form a transmit beam emitted by the antenna elements of the antenna panels 526.

Similar to the UE 502, the NAN 404 includes a host platform 528 coupled with a modem platform 530. The host platform 528 includes application processing circuitry 532 coupled with protocol processing circuitry 534 of the modem platform 530. The modem platform may further include digital baseband circuitry 536, transmit circuitry 538, receive circuitry 540, RF circuitry 542, RFFE circuitry 544, and antenna panels 546. The components of the NAN 404 may be similar to and substantially interchangeable with like-named components of the UE 502. In addition to performing data transmission/reception as described above, the components of the AN 508 may perform various logical functions that include, for example, RNC functions such as radio bearer management, uplink and downlink dynamic radio resource management, and data packet scheduling. Examples of the antenna elements of the antenna panels 526 and/or the antenna elements of the antenna panels 546 include planar inverted-F antennas (PIFAs), monopole antennas, dipole antennas, loop antennas, patch antennas, Yagi antennas, parabolic dish antennas, omni-directional antennas, and/or the like.

FIG. 6 illustrates components capable of reading instructions from a machine-readable or computer-readable medium (e.g., a non-transitory machine-readable storage medium) and perform any one or more of the methodologies discussed herein. Specifically, FIG. 6 shows hardware resources 600 including one or more processors (or processor cores) 610, one or more memory/storage devices 620, and one or more communication resources 630, each of which may be communicatively coupled via a bus 640 or other interface circuitry. For examples where node virtualization (e.g., NFV) is utilized, a hypervisor 602 may be executed to provide an execution environment for one or more network slices/sub-slices to utilize the hardware resources 600. In some examples, the hardware resources 600 may be implemented in or by an individual compute node, which may be housed in an enclosure of various form factors. In other examples, the hardware resources 600 may be implemented by multiple compute nodes that may be deployed in one or more data centers and/or distributed across one or more geographic regions.

The processors 610 may include, for example, a processor 612 and a processor 614. The processors 610 may be or include, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof.

The memory/storage devices 620 may include main memory, disk storage, or any suitable combination thereof. The memory/storage devices 620 may include, but are not limited to, any type of volatile, non-volatile, semi-volatile memory, and/or any combination thereof. As examples, the memory/storage devices 620 can be or include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level Phase Change Memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, and/or a combination of any of the aforementioned memory devices, and/or other memory.

The communication resources 630 may include interconnection or network interface controllers, components, or other suitable devices to communicate with one or more peripheral devices 604 or one or more databases 606 or other network elements via a network 608. For example, the communication resources 630 may include wired communication components (e.g., for coupling via USB, Ethernet, and/or the like), cellular communication components, NFC components, Bluetooth® (or Bluetooth® Low Energy) components, Wi-Fi® components, and other communication components.

Instructions 650 comprise software, program code, application(s), applet(s), an app(s), firmware, microcode, machine code, and/or other executable code for causing at least any of the processors 610 to perform any one or more of the methodologies and/or techniques discussed herein. The instructions 650 may reside, completely or partially, within at least one of the processors 610 (e.g., within the processor's cache memory), the memory/storage devices 620, or any suitable combination thereof. Furthermore, any portion of the instructions 650 may be transferred to the hardware resources 600 from any combination of the peripheral devices 604 or the databases 606. Accordingly, the memory of processors 610, the memory/storage devices 620, the peripheral devices 604, and the databases 606 are examples of computer-readable and machine-readable media.

In some examples, the peripheral devices 604 may represent one or more sensors such as, for example, exteroceptive sensors, proprioceptive sensors, and/or exproprioceptive sensors (e.g., sensors that capture, measure, or correlate internal states and external states). Examples of such sensors include, inter alia, inertia measurement units (IMU) comprising accelerometers, systems (MEMS) or gyroscopes, and/or magnetometers; microelectromechanical nanoelectromechanical systems (NEMS) comprising 3-axis accelerometers, 3-axis gyroscopes, and/or magnetometers; level sensors; flow sensors; temperature sensors/thermistors; pressure sensors; barometric pressure sensors; gravimeters; altimeters; image sensors/cameras; light detection and ranging (LiDAR) sensors; proximity sensors; depth sensors, ambient light sensors; optical light sensors; ultrasonic transceivers; microphones; and the like.

Additionally or alternatively, the peripheral devices 604 may represent one or more actuators such as, for example, soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms (e.g., wheels, axles, thrusters, propellers, engines, motors (e.g., those discussed previously), clutches, and the like), projectile actuators/mechanisms (e.g., mechanisms that shoot or propel objects or elements), and/or audible sound generators, visual warning devices, and/or other like electromechanical components.

### 3. Example Implementations

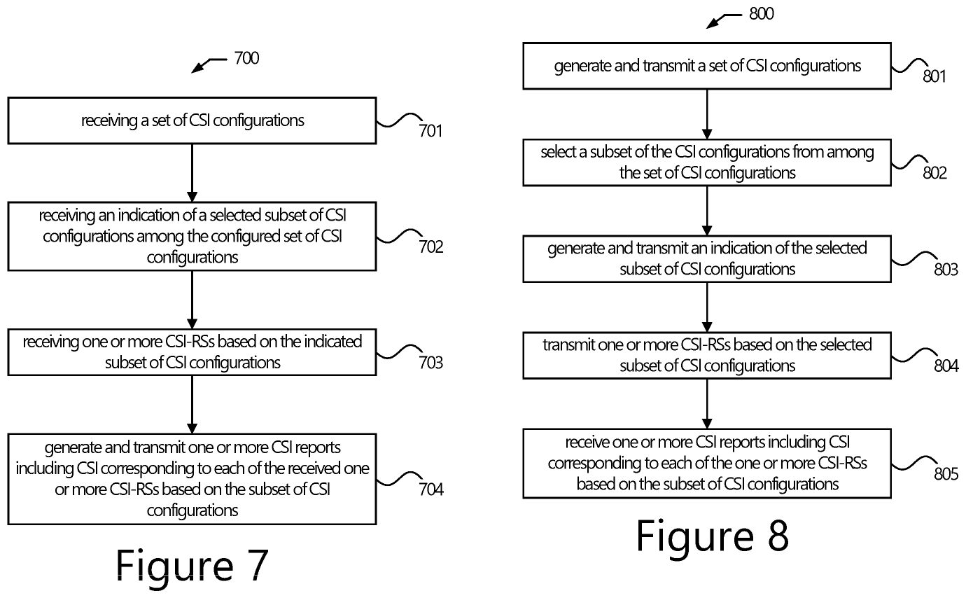

FIG. 7 shows an example process 700 to be performed by a UE 402. The process 700 includes receiving a set of channel state information (CSI) configurations (e.g., via RRC signaling) (701); receiving (e.g., via DCI, MAC CE, and/or the like) an indication (e.g., activation trigger and/or the like) to indicate a selected CSI configuration among the configured set of CSI configurations to be used (702); receiving at least one CSI-RS based on the indicated/selected CSI configuration (703); and generating and transmitting one or more CSI reports including CSI for each of the received one or more CSI-RS and according to the indicated subset of CSI configurations (704).

FIG. 8 shows an example process 800 to be performed by an NAN 414. The process 800 includes generating and transmitting a set of channel state information (CSI) configurations (e.g., to a UE 402) (801); selecting a subset of the CSI configurations from among the set of CSI configurations (802); generating and transmitting an indication (e.g., activation/trigger) of the selected subset of CSI configurations (e.g., to a UE 402) (803); transmitting one or more CSI reference signals (CSI-RSs) based on the selected subset of CSI configurations (804); and receiving one or more CSI reports including CSI corresponding to each of the received one or more CSI-RSs based on the subset of CSI configurations (805). In some examples, a CSI configuration is a subset of CSI-RS antenna ports of at least one of the CSI configurations of the set of CSI configurations.

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example 1 includes a method, comprising: receiving a channel state information (CSI) configuration including a set of CSI sub-configurations; receiving an indication of a selected subset of CSI sub-configurations among the configured subset of CSI sub-configurations to be used for receiving one or more CSI reference signals (CSI-RSs); receiving the one or more CSI-RSs based on the indicated subset of CSI sub-configurations; and transmitting one or more CSI reports including respective CSI for each of the received one or more CSI-RS and according to the indicated subset of CSI sub-configurations.

Example 2 includes a method comprising: receiving a channel state information (CSI) configuration including a set of sub-configurations; receiving an indication of a selected subset of sub-configurations among the configured subset of sub-configurations, wherein each sub-configuration in the subset of sub-configurations indicates one or more CSI reference signals (CSI-RSs) to be received; receiving the one or more CSI-RSs indicated by each sub-configuration in the subset of sub-configurations; and transmitting one or more CSI reports including CSI for each of received CSI-RS and according to each sub-configuration in the subset of sub-configurations

Example 3 includes a method, comprising: transmitting a channel state information (CSI) configuration including a set of CSI sub-configurations; selecting a subset of the CSI sub-configurations from among the set of CSI sub-configurations; transmitting an indication of the selected subset of CSI sub-configurations; transmitting one or more CSI-RS based on the selected subset of CSI sub-configurations; and receiving one or more CSI reports including CSI corresponding to each of the one or more CSI-RS based on the subset of CSI sub-configurations.

Example 4 includes a method, comprising: transmitting a channel state information (CSI) configuration including a set of sub-configurations; selecting a subset of the sub-configurations from among the set of sub-configurations, wherein each sub-configuration in the subset of the sub-configurations indicates one or more CSI reference signals (CSI-RSs) to be transmitted; transmitting an indication of the selected subset of sub-configurations; transmitting the one or more CSI-RS indicated by each sub-configuration of the subset of sub-configurations; and receiving one or more CSI reports including CSI corresponding to each of the transmitted one or more CSI-RSs

Example 5 includes the method of examples 1˜4 and/or some other example(s) herein, wherein the selected subset of CSI sub-configurations is/are activated after an activation period and/or after the reception of the indication.

Example 6 includes the method of examples 1-5 and/or some other example(s) herein, wherein each CSI sub-configuration is identified by a CSI configuration identifier (ID) and corresponds to a list of one or more CSI-RS resources.

Example 7 includes the method of examples 1-6 and/or some other example(s) herein, wherein each CSI sub-configuration is identified by a CSI configuration ID and corresponds to a CSI-RS antenna port subset.

Example 8 includes the method of example 7 and/or some other example(s) herein, wherein the CSI-RS antenna port subset is to be used to calculate the respective CSI.

Example 9 includes the method of example 8 and/or some other example(s) herein, wherein the CSI-RS antenna port subset of each CSI sub-configuration is indicated by a bitmap, wherein each bit in the bitmap indicates a corresponding antenna port that is enabled or disabled.

Example 10 includes the method of example 9 and/or some other example(s) herein, wherein the bitmap includes a bitmap pattern selected from a group comprising: A bit value of “0” in the bitmap indicates that a corresponding antenna port is disabled for the sub-configuration, and a bit value of “1” indicates that the corresponding antenna port is enabled and belongs to the CSI-RS antenna port subset for the sub-configuration.

Example 11 includes the method of examples 9-10 and/or some other example(s) herein, wherein the bitmap includes a bitmap pattern selected from a group comprising: antenna port with index 2*k, k=0, 1, . . . , N/2−1, enabled; antenna port with index 2*k+1, k=0, 1, . . . , N/2−1, enabled; antenna port with index k, k=0, 1, . . . , N/2−1, enabled; antenna port with index k, k=N/2, N/2+1, . . . , N−1, enabled; antenna port with index 4*k enabled, where k=0, 1, . . . , N/4−1; antenna port with index 4*k+1 enabled, where k=0, 1, . . . , N/4−1; antenna port with index 4*k+2 enabled, where k=0, 1, . . . , N/4−1; antenna port with index 4*k+3 enabled, where k=0, 1, . . . , N/4−1; antenna port with index k, k=0, 1, . . . , N/4−1, enabled; antenna port with index k, k=N/4, N/4+1, . . . , N/2−1, enabled; antenna port with index k, k=N/2, N/2+1, . . . , 3/4*N−1, enabled; and/or antenna port with index k, k=3/4*N, 3/4*N+1, . . . , N−1, enabled.

Example 12 includes the method of examples 1-11 and/or some other example(s) herein, wherein each CSI sub-configuration is identified by a CSI configuration ID and corresponds to a power offset for a physical downlink shared channel (PDSCH) relative to at least one of the one or more CSI-RSs.

Example 13 includes the method of example 12 and/or some other example(s) herein, wherein the power offset is to be used to calculate the respective CSI.

Example 14 includes the method of examples 12-13 and/or some other example(s) herein, wherein the power offset of each CSI sub-configuration includes a power offset between a PDSCH resource element and CSI-RS resource element.

Example 15 includes the method of examples 12-13 and/or some other example(s) herein, wherein the power offset of each CSI sub-configuration includes a power offset between a CSI-RS resource element and a secondary synchronization signal resource element.

Example 16 includes the method of examples 12-15 and/or some other example(s) herein, wherein the power offset is different than a power control offset used for a list of CSI-RS resources of each sub-configuration.

Example 17 includes the method of examples 1-16 and/or some other example(s) herein, wherein the method is performed by a user equipment (UE) or a radio access network (RAN) node.

Example 18 includes one or more computer readable media comprising instructions, wherein execution of the instructions by processor circuitry is to cause the processor circuitry to perform the method of any one of examples 1-17. Example 19 includes a computer program comprising the instructions of example 18. Example 20 includes an Application Programming Interface defining functions, methods, variables, data structures, and/or protocols for the computer program of example 19. Example 21 includes an API or specification defining functions, methods, variables, data structures, protocols, and the like, defining or involving use of any of examples 1-17 or portions thereof. Example 22 includes an apparatus comprising circuitry loaded with the instructions of example 18. Example 23 includes an apparatus comprising circuitry operable to run the instructions of example 18. Example 24 includes an integrated circuit comprising one or more of the processor circuitry and the one or more computer readable media of example 18. Example 25 includes a computing system comprising the one or more computer readable media and the processor circuitry of example 18. Example 26 includes an apparatus comprising means for executing the instructions of example 18. Example 27 includes a signal generated as a result of executing the instructions of example 18. Example 28 includes a data unit generated as a result of executing the instructions of example 18. Example 29 includes the data unit of example 28 and/or some other example(s) herein, wherein the data unit is a datagram, network packet, data frame, data segment, a Protocol Data Unit (PDU), a Service Data Unit (SDU), a message, or a database object. Example 30 includes a signal encoded with the data unit of examples 28-29. Example 31 includes an electromagnetic signal carrying the instructions of example 18. Example 32 includes an apparatus comprising means for performing the method of any one of examples 1-17 and/or some other example(s) herein. Example 33 includes an apparatus comprising: memory circuitry to store instructions; and processor connected to the memory circuitry, wherein the processor circuitry is to execute the instructions to perform the method of examples 1-17 and/or some other example(s) herein. Example 34 includes a wireless network according to the method of examples 1-17 and/or some other example(s) herein, and/or as shown and described herein.

For the purposes of the present document, the terminology discussed in '970 may be applicable to the examples and embodiments discussed herein. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The phrase “X(s)” means one or more X or a set of X. The description may use the phrases “in an embodiment,” “In some embodiments,” “in one implementation,” “In some implementations,” “in some examples”, and the like, each of which may refer to one or more of the same or different embodiments, implementations, and/or examples. Furthermore, the terms “comprising,” “including,” “having,” and the like, as used with respect to the present disclosure, are synonymous.

Although many of the examples discussed herein are provided with use of specific cellular/mobile network terminology, including with the use of 4G/5G 3GPP network components (or expected terahertz-based 6G/6G+ technologies), these examples may be applied to many other deployments of wide area and local wireless networks, as well as the integration of wired networks (including optical networks and associated fibers, transceivers, and/or the like). Furthermore, various standards (e.g, 3GPP, ETSI, IEEE, and/or the like) may define various message formats, PDUs, MAC CEs, containers, frames, and/or other data structures, as comprising a sequence of optional or mandatory containers, frames, data elements (DEs), data frames (DFs), information elements (IEs), information object classes (IOCs), managed object classes (MOCs), parameters, attributes, and/or other elements. However, the requirements of any particular standard should not limit the examples discussed herein, and as such, any combination of containers, frames, DFs, DEs, IEs, IOCs, MOCs, parameters, attributes, values, actions, features, and/or other elements are possible in various examples, including any combination of containers, frames, DFs, DEs, IEs, IOCs, MOCs, parameters, attributes, values, actions, features, and/or other elements that are strictly required to be followed in order to conform to such standards or any combination of containers, frames, DFs, DEs, IEs, IOCs, MOCs, parameters, attributes, values, actions, features, and/or other elements strongly recommended and/or used with or in the presence/absence of optional elements.

Moreover, the present disclosure provides various examples of names/labels for various systems, sub-systems, devices, planes, layers, protocols, components, operations, containers, frames, DFs, DEs, IEs, IOCs, MOCs, parameters, attributes, values, actions, features, and other elements/data structures. However, the specific names or labels used regarding the various systems, sub-systems, devices, planes, layers, components, operations, parameters, attributes, IEs, IOCs, MOCs, and other elements/data structures, are provided for the purpose of discussion and illustration, rather than limitation. The various systems, sub-systems, devices, planes, layers, components, operations, parameters, attributes, IEs, IOCs, MOCs, and other elements/data structures can have alternative names or labels to those provided herein. Furthermore, additional or alternative embodiments, implementations, and/or iterations of 3GPP specifications and/or other relevant standards/specifications may name certain elements/entities different to those discussed herein, but still fall within the context of the present disclosure.

Aspects of the inventive subject matter may be referred to herein, individually and/or collectively, merely for convenience and without intending to voluntarily limit the scope of this application to any single aspect or inventive concept. Although specific aspects have been shown and described herein, the present disclosure covers any and all adaptations or variations and any arrangement capable of achieving the same purpose may be substituted for the specific aspects 10 shown and described herein. Combinations of the described aspects and other aspects not specifically described herein will be apparent to those of skill in the art upon reviewing the present disclosure.

1-25. (canceled)

26. An apparatus for a user equipment (UE), the apparatus comprising:
processing circuitry, wherein to configure the UE for operation in a New Radio (NR) network, the processing circuitry is to:
decode a channel state information (CSI) configuration including a set of sub-configurations;
decode an indication of a selected subset of sub-configurations among the subset of sub-configurations, at least one sub-configuration in the subset of sub-configurations indicating one or more CSI reference signals (CSI-RSs) to be received;
decode the one or more CSI-RSs indicated by the at least one sub-configuration in the subset of sub-configurations; and
encode one or more CSI reports for transmission, the one or more CSI reports including CSI for the one or more CSI-RSs that are received from a base station and based on the at least one sub-configuration; and
memory coupled to the processing circuitry and configured to store the CSI configuration.

27. The apparatus of claim 26, wherein the selected subset of sub-configurations is activated after an activation period or after reception of the indication.

28. The apparatus of claim 27, wherein the at least one sub-configuration is identified by a CSI configuration identifier (ID) and corresponds to a list of one or more CSI-RS resources.

29. The apparatus of claim 27, wherein the at least one sub-configuration is identified by a CSI configuration identifier (ID) and corresponds to a CSI-RS antenna port subset.

30. The apparatus of claim 29, wherein the processing circuitry is to:
determine the CSI based on the CSI-RS antenna port subset.

31. The apparatus of claim 30, wherein the CSI-RS antenna port subset of the at least one sub-configuration is indicated by a bitmap, wherein the bitmap includes a sequence of bits, and wherein each bit in the sequence of bits corresponds to an antenna port to be enabled or disabled.

32. The apparatus of claim 31, wherein the bitmap includes a bitmap pattern selected from a group comprising of:
a bit value of “0”, indicating that a corresponding antenna port is disabled for the at least one sub-configuration; and
a bit value of “1”, indicating that the corresponding antenna port is enabled and belongs to the CSI-RS antenna port subset for the at least one sub-configuration.

33. The apparatus of claim 26, wherein each sub-configuration is identified by a CSI configuration ID and corresponds to a power offset for a physical downlink shared channel (PDSCH) relative to at least one of the one or more CSI-RSs.

34. The apparatus of claim 26, further comprising:
transceiver circuitry coupled to the processing circuitry; and
one or more antennas coupled to the transceiver circuitry.

35. A non-transitory computer-readable storage medium that stores instructions for execution by one or more processors of a user equipment (UE), the instructions to configure the UE for operation in a New Radio (NR) network, and to cause the UE to perform operations comprising:
decoding a channel state information (CSI) configuration including a set of sub-configurations;
decoding an indication of a selected subset of sub-configurations among the subset of sub-configurations, at least one sub-configuration in the subset of sub-configurations indicating one or more CSI reference signals (CSI-RSs) to be received;
decoding the one or more CSI-RSs indicated by the at least one sub-configuration in the subset of sub-configurations; and
encoding one or more CSI reports for transmission, the one or more CSI reports including CSI for the one or more CSI-RSs that are received from a base station and based on the at least one sub-configuration.

36. The non-transitory computer-readable storage medium of claim 35, wherein the selected subset of sub-configurations is activated after an activation period or after reception of the indication.

37. The non-transitory computer-readable storage medium of claim 36, wherein the at least one sub-configuration is identified by a CSI configuration identifier (ID) and corresponds to a list of one or more CSI-RS resources.

38. The non-transitory computer-readable storage medium of claim 36, wherein the at least one sub-configuration is identified by a CSI configuration identifier (ID) and corresponds to a CSI-RS antenna port subset.

39. The non-transitory computer-readable storage medium of claim 38, the operations comprising:
determining the CSI based on the CSI-RS antenna port subset.

40. A user equipment (UE) configured for operation in a New Radio (5G NR) network, the UE comprising:
front-end circuitry coupled to one or more antennas; and
processing circuitry coupled to the front-end circuitry, the processing circuitry is to:
decode a channel state information (CSI) configuration including a set of sub-configurations;
decode an indication of a selected subset of sub-configurations among the subset of sub-configurations, at least one sub-configuration in the subset of sub-configurations indicating one or more CSI reference signals (CSI-RSs) to be received;
decode the one or more CSI-RSs indicated by the at least one sub-configuration in the subset of sub-configurations; and
encode one or more CSI reports for transmission, the one or more CSI reports including CSI for the one or more CSI-RSs that are received from a base station and based on the at least one sub-configuration.

41. The UE of claim 40, wherein the selected subset of sub-configurations is activated after an activation period or after reception of the indication.

42. The UE of claim 41, wherein the at least one sub-configuration is identified by a CSI configuration identifier (ID) and corresponds to a list of one or more CSI-RS resources.

43. The UE of claim 41, wherein the at least one sub-configuration is identified by a CSI configuration identifier (ID) and corresponds to a CSI-RS antenna port subset.

44. The UE of claim 43, wherein the processing circuitry is to:
determine the CSI based on the CSI-RS antenna port subset.

45. The UE of claim 44, wherein the CSI-RS antenna port subset of the at least one sub-configuration is indicated by a bitmap, wherein the bitmap includes a sequence of bits, and wherein each bit in the sequence of bits corresponds to an antenna port to be enabled or disabled.
